(19) United States
(12) Patent Application Publication
(10) Pub. No.: US 2026/0089615 A1
(43) Pub. Date: Mar. 26, 2026

(54) COMMUNICATION METHOD AND APPARATUS

(71) Applicant: HUAWEI TECHNOLOGIES CO., LTD., Shenzhen (CN)

(72) Inventors: Lu Yang, Shenzhen (CN); Jun Wang, Shanghai (CN); Wenhui Wang, Shanghai (CN); Li Sun, Shenzhen (CN); Yan Xi, Shanghai (CN)

(73) Assignee: HUAWEI TECHNOLOGIES CO., LTD., Shenzhen (CN)

(21) Appl. No.: 19/403,352

(22) Filed: Nov. 28, 2025

Related U.S. Application Data
(63) Continuation of application No. PCT/CN2023/097617, filed on May 31, 2023.

(51) Int. Cl. H04W 48/16

(52) U.S. Cl. CPC H04W 48/16

(57) ABSTRACT

This application provides a communication method and apparatus, and belongs to the field of communication technologies. In the method, a first access network apparatus receives a candidate service cluster list, and sends first information to a first terminal based on the candidate service cluster list. The candidate service cluster list indicates one or more candidate service clusters, each of the one or more candidate service clusters includes one or more access network apparatuses, and each candidate service cluster includes the first access network apparatus. The first information indicates that a first service cluster serves the first terminal, and the first service cluster is a service cluster in the one or more candidate service clusters.

### CROSS-REFERENCE TO RELATED APPLICATIONS

This application is a continuation of International Application No. PCT/CN2023/097617, filed on May 31, 2023, the disclosures of the aforementioned application is hereby incorporated by reference in its entirety.

### TECHNICAL FIELD

This application relates to the communication field, and in particular, to a communication method and apparatus.

### BACKGROUND

In scenarios such as subways and railways, when terminals move fast, a large quantity of handovers occur, resulting in performance problems such as a high call drop rate, difficulty in access, and a low throughput. For the scenarios, a hyper cell is introduced to reduce the handovers and improve user experience. The hyper cell is a logical cell combining a plurality of transmission and reception points (TRPs), namely, common cells, that provide contiguous coverage and work in a same frequency band. After the hyper cell is established, all the TRPs use a same frequency, bandwidth, physical cell identifier (PCI), and cell global identifier (CGI) that correspond to the hyper cell, so that the terminal does not need to perform an inter-cell handover when moving between the TRPs.

However, a configuration of the hyper cell is relatively fixed and needs to be configured through manual participation. As a result, user experience is poor.

### SUMMARY

Embodiments of this application provide a communication method and apparatus, so that one or more candidate service clusters can be dynamically configured based on an actual situation, to further improve user experience.

According to a first aspect, a communication method is provided. The communication method includes: A first access network apparatus receives a candidate service cluster list, and sends first information to a first terminal based on the candidate service cluster list. The candidate service cluster list indicates one or more candidate service clusters, each of the one or more candidate service clusters includes one or more access network apparatuses, and each candidate service cluster includes the first access network apparatus. The first information indicates that a first service cluster serves the first terminal, and the first service cluster is a service cluster in the one or more candidate service clusters.

At least two access network apparatuses included in each of the one or more candidate service clusters are configured to jointly provide a service for a terminal, to ensure stability and reliability of the service.

It can be learned from the method according to the first aspect that, one or more different candidate service clusters are dynamically configured around a same access network apparatus, for example, the first access network apparatus, so that the first access network apparatus can select a service cluster suitable for a current actual situation, for example, the first service cluster, to provide a service for a first apparatus that accesses the first access network apparatus. This further improves user experience.

In a possible design solution, the candidate service cluster list further indicates a service condition of the one or more candidate service clusters, and the first service cluster is a service cluster that meets a service condition. This ensures that the first service cluster can provide a good service for the first terminal.

For example, that a candidate service cluster meets a service condition may include at least one of the following items: A service area of the candidate service cluster covers a location of a terminal, current communication quality between the candidate service cluster and the terminal is higher than a communication quality threshold, a quantity of terminals currently served by the candidate service cluster is less than a preset quantity of terminals, or a quantity of currently available resources of the candidate service cluster is greater than a preset quantity of resources.

The location of the terminal may be a location to which the terminal may move. For example, the first access network apparatus may predict, based on a current location of the terminal and a current movement direction of the terminal, the location to which the terminal may move. In this case, the first access network apparatus may select, from the one or more candidate service clusters, a candidate service cluster in which a service area of an access network apparatus (for example, an access network apparatus other than the first access network apparatus in the candidate service cluster) in the candidate service cluster can cover at least a part or all of the location to which the terminal may move, to reduce a quantity of handovers of the terminal, and avoid performance deterioration caused by frequent handovers. That the current communication quality between the candidate service cluster and the terminal is higher than the communication quality threshold may be understood as that the current communication quality between the candidate service cluster and the terminal is good, to avoid that service quality cannot be ensured due to poor communication quality. That the quantity of terminals currently served by the candidate service cluster is less than the preset quantity of terminals may be understood as that the quantity of terminals currently served by the candidate service cluster is small, to avoid service congestion caused by an excessive quantity of terminals, thereby ensuring the service quality. That the quantity of currently available resources of the candidate service cluster is greater than the preset quantity of resources may be understood as that the quantity of currently available resources of the candidate service cluster is sufficient, to avoid that the service quality cannot be ensured due to insufficient available resources.

Optionally, that the first service cluster meets the service condition includes at least one of the following items: A service area of the first service cluster covers a location of a terminal, current communication quality between the first service cluster and the terminal is higher than a communication quality threshold, a quantity of terminals currently served by the first service cluster is less than a preset quantity of terminals, or a quantity of currently available resources of the first service cluster is greater than a preset quantity of resources.

In a possible design solution, the first information includes at least one of the following items: an identifier of the first service cluster, an identifier of the first terminal, or an identifier of an access network apparatus included in the first service cluster.

In a possible design solution, the method according to the first aspect may further include: The first access network apparatus sends second information to a second access network apparatus, where the second access network apparatus is an access network apparatus in the first service cluster, and the second information indicates information about the first service cluster.

Optionally, the information about the first service cluster includes at least one of the following items: the identifier of the first service cluster, an identifier of a terminal served by the first service cluster, or an identifier of the first access network apparatus.

In this way, the first terminal can be aligned with the access network apparatus in the first service cluster, in other words, the first terminal can learn of a specific access network apparatus that can provide a service for the first terminal, and the access network apparatus in the first service cluster can also learn of a specific terminal that can be served by the access network apparatus.

In a possible design solution, that the first access network apparatus receives the candidate service cluster list includes: The first access network apparatus sends a candidate service cluster list request to a management network element based on information from the first terminal, to receive the candidate service cluster list returned by the management network element based on the candidate service cluster list request. The management network element is a network element that manages the first access network apparatus. In other words, the terminal triggers the first access network apparatus to request the candidate service cluster list from the management network element, to implement that movement of the terminal triggers delivery of a candidate service cluster list matching the location of the terminal, thereby ensuring that a service obtained by a user in real time is good.

In another possible design solution, that the first access network apparatus receives the candidate service cluster list includes: The first access network apparatus periodically receives the candidate service cluster list from a management network element. The management network element is a network element that manages the first access network apparatus. In other words, a network side (the management network element) may actively update the candidate service cluster list, to ensure that performance of each service cluster is good.

Optionally, the method according to the first aspect may further include: The first access network apparatus receives information from the first terminal. Correspondingly, that the first access network apparatus sends the first information to the first terminal based on the candidate service cluster list includes: The first access network apparatus sends, in response to the information from the first terminal, the first information to the first terminal based on the candidate service cluster list. In other words, the terminal triggers the first access network apparatus to send the first information to the terminal, and it is not that the first access network apparatus may send information to the terminal at any occasion, to avoid unnecessary overheads caused by frequent information sending.

Optionally, the information from the first terminal includes at least one of the following items: representing that the first terminal successfully accesses the first access network apparatus, a measurement result of a downlink channel between the first access network apparatus and the first terminal, or the information from the first terminal being an uplink reference signal sent by the first terminal. In other words, the first terminal may send the information to the first access network apparatus at any possible occasion, for example, when the access succeeds, when downlink measurement is completed, or when uplink measurement starts, to trigger a service provided by a service cluster for the first terminal. A specific occasion is selected based on an actual situation. This is not limited in this embodiment of this application.

In a possible design solution, the method according to the first aspect may further include: The first access network apparatus receives third information. The third information may indicate the communication quality between the first terminal and the first service cluster, and is used by the first access network apparatus to evaluate service quality of the first service cluster, to prepare for a subsequent handover between service clusters.

According to a second aspect, a communication method is provided. The communication method includes: A management network element generates a candidate service cluster list, and sends the candidate service cluster list to a first access network apparatus. The candidate service cluster list indicates one or more candidate service clusters, each of the one or more candidate service clusters includes one or more access network apparatuses, and each candidate service cluster includes the first access network apparatus.

In a possible design solution, that the management network element generates the candidate service cluster list includes: A service cluster in the candidate service cluster list is a service cluster whose service performance is higher than preset service performance in a service cluster set.

Optionally, an access network apparatus included in each service cluster in the service cluster set is an access network apparatus managed by the management network element, each service cluster in the service cluster set includes one or more access network apparatuses, and each service cluster includes the first access network apparatus.

Further, service performance of any service cluster in the service cluster set may be represented by using at least one of the following items: a communication capacity of the service cluster, a communication rate of the service cluster, or communication quality of the service cluster.

It may be understood that a communication capacity of each service cluster may represent a maximum communication rate that can be theoretically reached by the service cluster. A larger communication capacity indicates a larger maximum communication rate and better service performance of the service cluster. A communication rate of each service cluster may represent a speed of data transmission between a terminal in the service cluster and an access network apparatus in the service cluster. A higher speed of data transmission indicates better service performance. Communication quality of each service cluster may represent signal quality between a terminal in the service cluster and an access network apparatus in the service cluster, for example, reference signal received power. Better signal quality indicates better service performance.

In a possible design solution, the candidate service cluster list further indicates a service condition of the one or more candidate service clusters.

Optionally, that a service cluster in the one or more candidate service clusters meets a service condition includes at least one of the following items: A service area of the service cluster covers a location of a terminal, current communication quality between the service cluster and the terminal is higher than a communication quality threshold, a quantity of terminals currently served by the service cluster is less than a preset quantity of terminals, or a quantity of currently available resources of the service cluster is greater than a preset quantity of resources.

In a possible design solution, the candidate service cluster list further indicates a priority of the one or more candidate service clusters, and the priority of the one or more candidate service clusters is determined based on respective service performance of the one or more candidate service clusters.

Optionally, the respective service performance of the one or more candidate service clusters is represented by using at least one of the following items: a respective communication capacity of the one or more candidate service clusters, a respective communication rate of the one or more candidate service clusters, or respective communication quality of the one or more candidate service clusters.

In a possible design solution, that the management network element generates the candidate service cluster list includes: The management network element receives a candidate service cluster list request from the first access network apparatus, and generates the candidate service cluster list based on the candidate service cluster list request.

In a possible design solution, that the management network element generates the candidate service cluster list includes: The management network element periodically generates the candidate service cluster list.

Optionally, that the management network element sends the candidate service cluster list to the first access network apparatus includes: The management network element periodically sends the candidate service cluster list to the first access network apparatus.

In a possible design solution, at least two access network apparatuses included in each of the one or more candidate service clusters are configured to jointly provide a service for a terminal.

In addition, for other technical effects of the communication method according to the second aspect, refer to the technical effects of the communication method according to the first aspect. Details are not described herein again.

According to a third aspect, a communication method is provided. The communication method includes: A first terminal receives first information from a first access network apparatus, and communicates with a first service cluster based on the first information. The first information indicates that the first service cluster serves the first terminal, and one or more access network apparatuses included in the first service cluster include the first access network apparatus.

In a possible design solution, that the first terminal communicates with the first service cluster based on the first information includes: The first terminal sends measurement information to the first service cluster based on the first information. The measurement information indicates communication quality between the first terminal and the first service cluster.

Optionally, the communication quality between the first terminal and the first service cluster is determined based on communication quality between the first terminal and each of at least one access network apparatus in the first service cluster. In other words, the first terminal can determine the communication quality between the first terminal and the first service cluster based on the communication quality between the first terminal and the at least one access network apparatus in the first service cluster.

Optionally, the measurement information further includes an identifier of the first service cluster, to explicitly indicate the first service cluster, or the measurement information may implicitly indicate the first service cluster in another manner, for example, based on an information type. This is not specifically limited herein.

It may be understood that, because the first terminal can comprehensively evaluate the communication quality between the first terminal and the first service cluster, the first terminal may directly send the measurement information to the first access network apparatus in the first service cluster, to avoid unnecessary overheads caused by sending the measurement information to another access network apparatus in the first service cluster.

In another possible design solution, that the first terminal communicates with the first service cluster based on the first information includes: The first terminal sends a reference signal to the first service cluster based on the first information.

In addition, for other technical effects of the communication method according to the third aspect, refer to the technical effects of the communication method according to the first aspect. Details are not described herein again.

According to a fourth aspect, a communication apparatus is provided. The communication apparatus includes modules configured to perform the method according to the first aspect, for example, a transceiver module and a processing module. For example, the transceiver module is configured to perform receiving and sending functions of the communication apparatus, and the processing module is configured to perform a function of the communication apparatus other than the receiving and sending functions.

Optionally, the transceiver module may include a sending module and a receiving module. The sending module is configured to implement a sending function of the communication apparatus according to the fourth aspect, and the receiving module is configured to implement a receiving function of the communication apparatus according to the fourth aspect.

Optionally, the communication apparatus according to the fourth aspect may further include a storage module. The storage module stores a program or instructions. When the processing module executes the program or the instructions, the communication apparatus is enabled to perform the method according to the first aspect.

It may be understood that the communication apparatus according to the fourth aspect may be a network device, may be a chip (system) or another part or component that may be disposed in the network device, or may be an apparatus including the network device. This is not limited in this application.

In addition, for technical effects of the communication apparatus according to the fourth aspect, refer to the technical effects of the method according to the first aspect. Details are not described herein again.

According to a fifth aspect, a communication apparatus is provided. The communication apparatus includes modules configured to perform the method according to the second aspect, for example, a transceiver module and a processing module. For example, the transceiver module is configured to perform receiving and sending functions of the communication apparatus, and the processing module is configured to perform a function of the communication apparatus other than the receiving and sending functions.

Optionally, the transceiver module may include a sending module and a receiving module. The sending module is configured to implement a sending function of the communication apparatus according to the fifth aspect, and the receiving module is configured to implement a receiving function of the communication apparatus according to the fifth aspect.

Optionally, the communication apparatus according to the fifth aspect may further include a storage module. The storage module stores a program or instructions. When the processing module executes the program or the instructions, the communication apparatus is enabled to perform the method according to the second aspect.

It may be understood that the communication apparatus according to the fifth aspect may be a network device, may be a chip (system) or another part or component that may be disposed in the network device, or may be an apparatus including the network device. This is not limited in this application.

In addition, for technical effects of the communication apparatus according to the fifth aspect, refer to the technical effects of the method according to the second aspect. Details are not described herein again.

According to a sixth aspect, a communication apparatus is provided. The communication apparatus includes modules configured to perform the method according to the third aspect, for example, a transceiver module and a processing module. For example, the transceiver module is configured to perform receiving and sending functions of the communication apparatus, and the processing module is configured to perform a function of the communication apparatus other than the receiving and sending functions.

Optionally, the transceiver module may include a sending module and a receiving module. The sending module is configured to implement a sending function of the communication apparatus according to the sixth aspect, and the receiving module is configured to implement a receiving function of the communication apparatus according to the sixth aspect.

Optionally, the communication apparatus according to the sixth aspect may further include a storage module. The storage module stores a program or instructions. When the processing module executes the program or the instructions, the communication apparatus is enabled to perform the method according to the third aspect.

It may be understood that the communication apparatus according to the sixth aspect may be a terminal, may be a chip (system) or another part or component that may be disposed in the terminal, or may be an apparatus including the terminal. This is not limited in this application.

In addition, for technical effects of the communication apparatus according to the sixth aspect, refer to the technical effects of the method according to the third aspect. Details are not described herein again.

According to a seventh aspect, a communication apparatus is provided. The communication apparatus includes a processor. The processor is configured to perform the method according to any one of the possible implementations of the first aspect to the third aspect.

In a possible design solution, the communication apparatus according to the seventh aspect may further include a transceiver. The transceiver may be a transceiver circuit or an interface circuit. The transceiver may be used by the communication apparatus according to the seventh aspect to communicate with another communication apparatus.

In a possible design solution, the communication apparatus according to the seventh aspect may further include a memory. The memory and the processor may be integrated together, or may be separately disposed. The memory may be configured to store a computer program and/or data in the method according to any one of the first aspect to the third aspect.

In this embodiment of this application, the communication apparatus according to the seventh aspect may be the device or the apparatus according to any one of the first aspect to the third aspect, may be a chip (system) or another part or component that may be disposed in the device or the apparatus, or may be an apparatus including the device or the apparatus.

In addition, for technical effects of the communication apparatus according to the seventh aspect, refer to the technical effects of the method according to any one of the implementations of the first aspect to the third aspect. Details are not described herein again.

According to an eighth aspect, a communication apparatus is provided. The communication apparatus includes a processor, where the processor is coupled to a memory, and the processor is configured to execute a computer program stored in the memory, to enable the communication apparatus to perform the method according to any one of the possible implementations of the first aspect to the third aspect.

In a possible design solution, the communication apparatus according to the eighth aspect may further include a transceiver. The transceiver may be a transceiver circuit or an interface circuit. The transceiver may be used by the communication apparatus according to the eighth aspect to communicate with another communication apparatus.

In this embodiment of this application, the communication apparatus according to the eighth aspect may be the device or the apparatus according to any one of the first aspect to the third aspect, may be a chip (system) or another part or component that may be disposed in the device or the apparatus, or may be an apparatus including the device or the apparatus.

In addition, for technical effects of the communication apparatus according to the eighth aspect, refer to the technical effects of the method according to any one of the implementations of the first aspect to the third aspect. Details are not described herein again.

According to a ninth aspect, a communication apparatus is provided. The apparatus includes a processor and a memory. The memory is configured to store a computer program. When the processor executes the computer program, the communication apparatus is enabled to perform the method according to any one of the implementations of the first aspect to the third aspect.

In a possible design solution, the communication apparatus according to the ninth aspect may further include a transceiver. The transceiver may be a transceiver circuit or an interface circuit. The transceiver may be used by the communication apparatus according to the ninth aspect to communicate with another communication apparatus.

In this embodiment of this application, the communication apparatus according to the ninth aspect may be the device or the apparatus according to any one of the first aspect to the third aspect, may be a chip (system) or another part or component that may be disposed in the device or the apparatus, or may be an apparatus including the device or the apparatus.

In addition, for technical effects of the communication apparatus according to the ninth aspect, refer to the technical effects of the method according to any one of the implementations of the first aspect to the third aspect. Details are not described herein again.

According to a tenth aspect, a computer-readable storage medium is provided, and includes a computer program or instructions. When the computer program or the instructions are run on a computer, the computer is enabled to perform the method according to any one of the possible implementations of the first aspect to the third aspect.

According to an eleventh aspect, a computer program product is provided, and includes a computer program or instructions. When the computer program or the instructions are run on a computer, the computer is enabled to perform the method according to any one of the possible implementations of the first aspect to the third aspect.

### BRIEF DESCRIPTION OF DRAWINGS

FIG. 1 is a diagram of a scenario of intra-base-station UL CoMP;

FIG. 2 is a diagram of a scenario of intra-base-station DL CoMP;

FIG. 3 is a diagram of a scenario of a hyper cell;

FIG. 4 is a diagram of an architecture of a communication system according to an embodiment of this application;

FIG. 5 is a schematic flowchart 1 of a communication method according to an embodiment of this application;

FIG. 6 is a diagram of an application scenario of a communication method according to an embodiment of this application;

FIG. 7 is a schematic flowchart 2 of a communication method according to an embodiment of this application;

FIG. 8 is a schematic flowchart 3 of a communication method according to an embodiment of this application;

FIG. 9 is a diagram 1 of a structure of a communication apparatus according to an embodiment of this application; and

FIG. 10 is a diagram 2 of a structure of a communication apparatus according to an embodiment of this application.

### DESCRIPTION OF EMBODIMENTS

Technical terms used in this application are first described.

As a user quantity and traffic increase sharply, density of deploying base stations by an operator is higher. Although a capacity is increased, a quantity of overlapping coverage areas of base stations is also increased, deteriorating experience of a cell edge user. To improve the experience of the edge user, a plurality of coordination mechanisms are introduced, in other words, a plurality of base stations (or a plurality of antennas) jointly serve the user, to meet a requirement of improving the experience of the edge user. Current coordination mechanisms mainly include coordinated multipoint transmission/reception (CoMP) and a hyper cell, which are separately described below.

### 1. CoMP:

To improve spectrum resource utilization, a new radio (NR) system usually uses intra-frequency networking. In the intra-frequency networking, interference between cells is strong, and the experience of the cell edge user is usually poor. Therefore, a CoMP function may be used to improve user experience of the cell edge user.

The CoMP refers to jointly processing service channel data of a user in an overlapping area by a serving cell and an intra-frequency neighboring cell, to improve user experience of the cell edge user. The serving cell is a cell accessed by a UE. The intra-frequency neighboring cell is an intra-frequency neighboring cell that performs joint transmitting or reception with the serving cell, for example, is an intra-base-station intra-frequency neighboring cell, also referred to as a cooperating cell. The overlapping area is an overlapping area covered by cells. A UE whose data is jointly transmitted or received by the serving cell and the cooperating cell is also referred to as a CoMP UE. Based on a data sending direction, the CoMP may include uplink (UL) CoMP, for example, intra-base-station UL CoMP, and downlink (DL) CoMP, for example, intra-base-station DL CoMP.

As shown in FIG. 1, intra-base-station UL CoMP refers to performing inter-cell joint reception of data of a UE. For example, a base station uses antennas of a serving cell and an intra-base-station intra-frequency neighboring cell to jointly receive signals on a physical uplink shared channel (PUSCH) of a UE in an overlapping area. Then, the base station combines the signals in the serving cell to suppress interference and increase reference signal received power (RSRP), thereby improving user experience.

As shown in FIG. 2, intra-base-station DL CoMP refers to performing inter-cell joint transmitting of data of a UE. For example, a base station uses antennas of a serving cell and an intra-base-station intra-frequency neighboring cell to jointly transmit signals on a physical downlink shared channel (PDSCH) of a UE in an overlapping area, thereby improving a user throughput. In addition, the intra-base-station DL CoMP is also referred to as intra-base-station joint transmission (JT).

### 2. Hyper Cell:

In scenarios such as subways and railways, when UEs move fast, a large quantity of handovers occur, resulting in performance problems such as a high call drop rate, difficulty in access, and a low throughput. For the scenarios, a hyper cell is introduced to reduce the handovers and improve user experience.

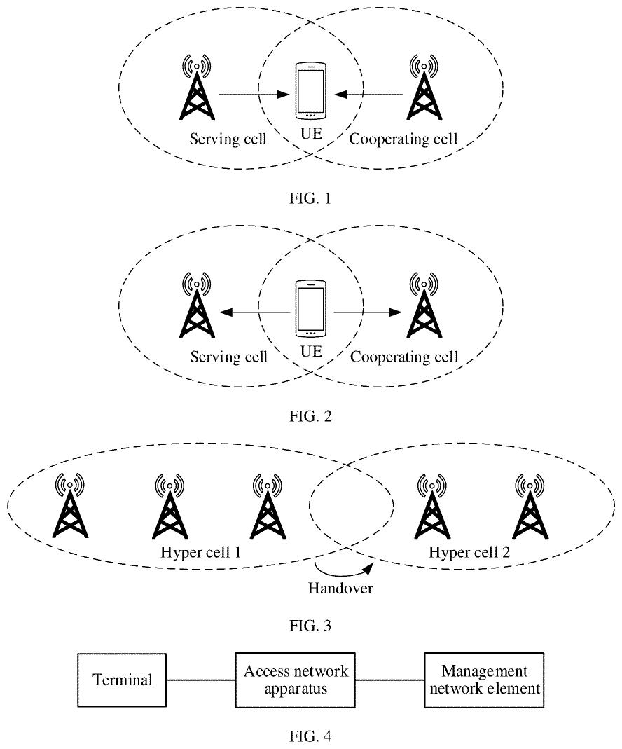

As shown in FIG. 3, a hyper cell is a logical cell combining a plurality of TRPs, namely, common cells, that provide contiguous coverage and work in a same frequency band. After the hyper cell is established, all the TRPs use a same frequency, bandwidth, PCI, and CGI that correspond to the hyper cell, so that a UE does not need to perform an inter-cell handover when moving between the TRPs. In this way, a problem of performance deterioration caused by the handover is reduced.

It may be understood that, both CoMP and the hyper cell are relatively fixed in terms of configuration, and cannot change dynamically as an environment or an application scenario changes. Consequently, a service is limited.

The following describes technical solutions of this application with reference to accompanying drawings.

The technical solutions in embodiments of this application may be applied to various communication systems, for example, a wireless network (Wi-Fi) system, a vehicle to everything (V2X) communication system, a device-to-device (D2D) communication system, an internet of vehicles communication system, a 4th generation (4G) mobile communication system like a long term evolution (LTE) system, a 5th generation (5G) system like an NR system, and a communication system evolved after 5G, for example, a 6th generation (6G) communication system.

In embodiments of this application, an “indication” may include a direct indication and an indirect indication, or may include an explicit indication and an implicit indication. Information indicated by specific information (for example, first information, second information, or third information in the following) is referred to as to-be-indicated information. In this case, in a specific implementation process, the to-be-indicated information may be indicated in a plurality of manners, for example, but not limited to, directly indicating the to-be-indicated information, for example, indicating the to-be-indicated information or an index of the to-be-indicated information. The to-be-indicated information may alternatively be indirectly indicated by indicating other information, where there is an association relationship between the other information and the to-be-indicated information. Alternatively, only a part of the to-be-indicated information may be indicated, and the other part of the to-be-indicated information is known or pre-agreed on. For example, specific information may be indicated by using an arrangement sequence of each piece of information that is pre-agreed on (for example, specified in a protocol), to reduce indication overheads to some extent. In addition, a common part of each piece of information may be identified and indicated in a unified manner, to reduce indication overheads caused by separately indicating same information.

In addition, specific indication manners may alternatively be various existing indication manners, for example, but not limited to, the foregoing indication manners and various combinations thereof. It can be learned from the foregoing descriptions that, for example, when a plurality of pieces of information of a same type need to be indicated, different information may be indicated in different manners. In a specific implementation process, a needed indication manner may be selected based on a specific need. A selected indication manner is not limited in embodiments of this application. In this way, the indication manner in embodiments of this application should be understood as covering various methods that can enable a to-be-indicated party to learn of the to-be-indicated information.

It should be understood that the to-be-indicated information may be sent as a whole, or may be divided into a plurality of pieces of sub-information for separate sending, and sending periodicities and/or sending occasions of these pieces of sub-information may be the same or different. A specific sending method is not limited in embodiments of this application. The sending periodicities and/or the sending occasions of these pieces of sub-information may be pre-defined, for example, pre-defined according to a protocol, or may be configured by sending configuration information by a transmit-end device to a receive-end device.

“Pre-definition” or “pre-configuration” may be implemented by pre-storing, in a device, corresponding code, a table, or another manner that may indicate related information. A specific implementation of the “pre-definition” or “pre-configuration” is not limited in embodiments of this application. “Storing” may be storing in one or more memories. The one or more memories may be separately disposed, or may be integrated into an encoder or a decoder, a processor, or a communication apparatus. Alternatively, some of the one or more memories may be separately disposed, and some of the one or more memories are integrated into a decoder, a processor, or a communication apparatus. A type of the memory may be a storage medium in any form. This is not limited in embodiments of this application.

The “protocol” in embodiments of this application may be a protocol family in the communication field, a standard protocol with a frame structure similar to that of a protocol family, or a related protocol applied to a future communication system. This is not specifically limited in embodiments of this application.

In embodiments of this application, descriptions such as “when . . . ”, “in a case of . . . ”, and “if” all mean that a device performs corresponding processing in an objective case, and do not limit time, and the device is not required to perform a determining action during implementation. This does not mean that there is another limitation.

In descriptions of embodiments of this application, unless otherwise specified, “/” represents an “or” relationship between associated objects. For example, A/B may represent A or B. “And/or” in embodiments of this application describes only an association relationship for describing associated objects and represents that three relationships may exist. For example, A and/or B may represent the following three cases: only A exists, both A and B exist, and only B exists, where A and B may be singular or plural. In addition, in the descriptions of embodiments of this application, unless otherwise specified, “a plurality of” means two or more. “At least one of the following items (pieces)” or a similar expression thereof refers to any combination of these items, including any combination of singular items (pieces) or plural items (pieces). For example, at least one item (piece) of a, b, or c may indicate a, b, c, a and b, a and c, b and c, or a, b, and c, where a, b, and c may be singular or plural. In addition, to clearly describe the technical solutions in embodiments of this application, words such as “first” and “second” are used in embodiments of this application to distinguish between same items or similar items that provide basically same functions or purposes. A person skilled in the art may understand that the words such as “first” and “second” do not limit a quantity and an execution sequence, and the words such as “first” and “second” do not limit a definite difference. In addition, in embodiments of this application, a word like “example” or “for example” is used to represent giving an example, an illustration, or a description. Any embodiment or design solution described as an “example” or “for example” in embodiments of this application should not be explained as being more preferred or having more advantages than another embodiment or design solution. Specifically, the word like “example” or “for example” is intended to present a related concept in a specific manner for ease of understanding.

A network architecture and a service scenario described in embodiments of this application are intended to describe the technical solutions in embodiments of this application more clearly, and do not constitute a limitation on the technical solutions provided in embodiments of this application. A person of ordinary skill in the art may learn that: With the evolution of the network architecture and the emergence of new service scenarios, the technical solutions provided in embodiments of this application are also applicable to similar technical problems.

For ease of understanding embodiments of this application, a communication system shown in FIG. 4 is first used as an example to describe in detail a communication system applicable to embodiments of this application. For example, FIG. 4 is a diagram of an architecture of a communication system to which a communication method according to an embodiment of this application is applicable.

As shown in FIG. 4, the communication system may include a terminal, an access network apparatus, and a management network element.

There may be one or more terminals, for example, a first terminal, a second terminal, and a third terminal. The terminal may be a terminal having receiving and sending functions, or may be a chip or a chip system disposed in the terminal. The terminal may also be referred to as a user equipment (UE), an access terminal, a subscriber unit, a subscriber station, a mobile station (MS), a remote station, a remote terminal, a mobile device, a user terminal, a terminal, a wireless communication device, a user agent, or a user apparatus. The terminal in embodiments of this application may be a mobile phone, a cellular phone, a smartphone, a tablet computer (Pad), a wireless data card, a personal digital assistant (PDA), a wireless modem, a handheld device (handset), a laptop computer, a machine type communication (MTC) terminal, a computer having a wireless transceiver function, a virtual reality (VR) terminal, an augmented reality (AR) terminal, a smart home device (for example, a refrigerator, a TV, an air conditioner, or a meter), a smart robot, a robot arm, a workshop device, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, a vehicle-mounted terminal, a road side unit (RSU) or the like having a terminal function, a flight device (for example, a smart robot, a hot air balloon, an uncrewed aerial vehicle, or an airplane), or the like. The terminal in this application may alternatively be a vehicle-mounted module, a vehicle-mounted assembly, a vehicle-mounted component, a vehicle-mounted chip, or a vehicle-mounted unit that is built in a vehicle as one or more components or units. The terminal device may alternatively be another device having a terminal function. For example, the terminal device may alternatively be a device that functions as a terminal in D2D communication.

A device form of the terminal is not limited in embodiments of this application. An apparatus configured to implement a function of the terminal device may be a terminal device, or may be an apparatus that can support the terminal device in implementing the function, for example, a chip system. The apparatus may be mounted in the terminal device or used together with the terminal device. In embodiments of this application, the chip system may include a chip, or may include a chip and another discrete component.

There may be a plurality of access network apparatuses, for example, a first access network apparatus, a second access network apparatus, and a third access network apparatus. The access network apparatus may be a device having a wireless transceiver function, or may be a chip or a chip system disposed in the device, and is located in an access network (AN) of the communication system, to provide an access service for the terminal. For example, the access network apparatus may be referred to as a radio access network (RAN) device, and may be specifically an access network device in a next-generation mobile communication system, for example, a 6G mobile communication system. For example, the access network apparatus may be a 6G base station. Alternatively, in the next-generation mobile communication system, the access network apparatus may be named in another manner, which falls within the protection scope of embodiments of this application. This is not limited in this application. Alternatively, the access network apparatus may include a gNB in 5G, for example, a new radio (NR) system, may include one or a group of antenna panels (including a plurality of antenna panels) of a base station in 5G, or may be a network node that forms a gNB, a transmission point (transmission reception point, TRP, or transmission point, TP), or a transmission measurement function (TMF), for example, a central unit (CU), a distributed unit (DU), a CU-control plane (control plane, CP), or a CU-user plane (user plane, UP), a radio unit (RU), an RSU having a base station function, a wired access gateway, or a 5G core network element. Alternatively, the access network apparatus may further include an access point (AP) in a wireless fidelity (Wi-Fi) system, a wireless relay node, a wireless backhaul node, various forms of macro base stations, a micro base station (also referred to as a small cell), a relay station, an access point, a wearable device, a vehicle-mounted device, or the like.

The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that a network device may be a CU node, a DU node, or a device including a CU node and a DU node. In addition, the CU may be classified as a network device in an access network RAN, or the CU may be classified as a network device in a core network CN. This is not limited herein.

In different systems, the CU (or the CU-CP and the CU-UP), the DU, or the RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

In embodiments of this application, a form of the network device is not limited. An apparatus configured to implement a function of the network device may be a network device, or may be an apparatus that can support the network device in implementing the function, for example, a chip system. The apparatus may be mounted in the network device or used together with the network device.

The management network element may be configured to manage the foregoing one or more access network apparatuses. For example, the management network element is located in an AN, and may be specifically a RAN controller, or the management network element is located in a core network (CN), and may be, for example, an access and mobility management function (AMF) network element, or the management network element may be replaced with any possible network element or entity, for example, any possible network element or entity in a management domain.

In the communication system, the management network element may select one access network apparatus, for example, the first access network apparatus, from the one or more access network apparatuses managed by the management network element, to dynamically configure one or more different candidate service clusters. For example, each candidate service cluster includes one or more access network apparatuses, and each candidate service cluster includes the first access network apparatus. The management network element may send, to the first access network apparatus, a candidate service cluster list corresponding to the one or more candidate service clusters, so that the first access network apparatus may select, from the candidate service cluster list, a service cluster suitable for a current actual situation, for example, a first service cluster, to provide a service for a first apparatus that accesses the first access network apparatus, thereby avoiding a limitation on actual application.

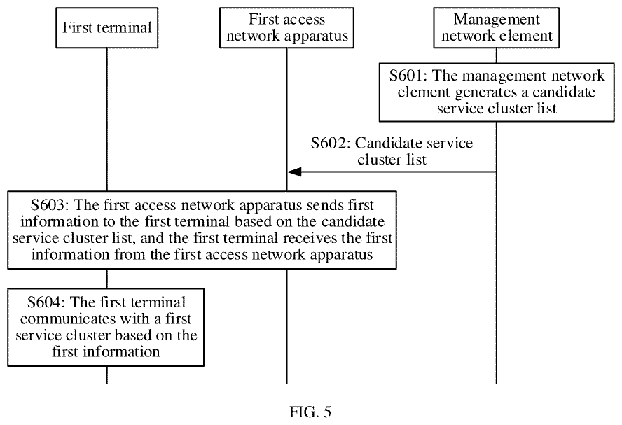

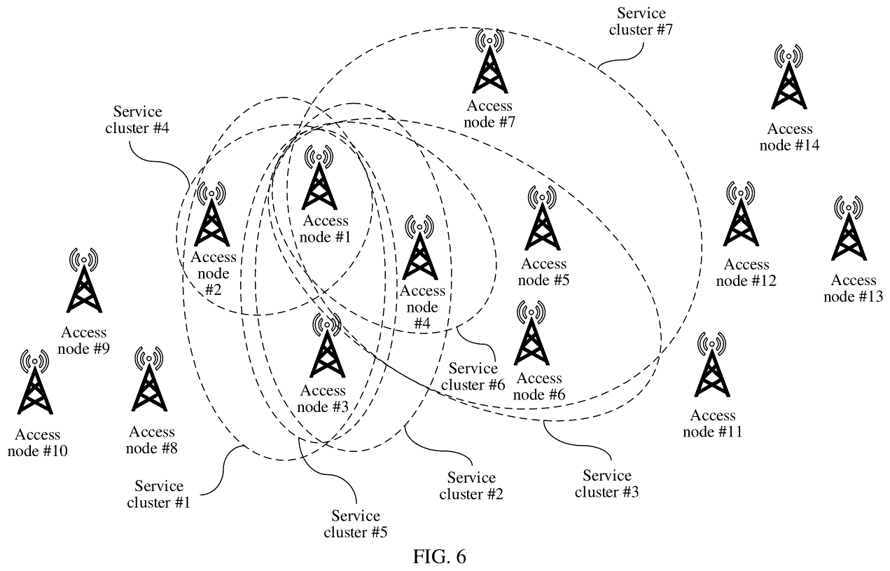

The following describes in detail communication methods provided in embodiments of this application with reference to FIG. 5 to FIG. 8.

FIG. 5 is a schematic flowchart 1 of a communication method according to an embodiment of this application. The communication method is applicable to the foregoing communication system, and mainly relates to interaction between a first terminal, a first access network apparatus, and a management network element.

Specifically, as shown in FIG. 5, a procedure of the communication method is shown below.

S601: The management network element generates a candidate service cluster list.

The candidate service cluster list may indicate one or more candidate service clusters. For example, the candidate service cluster list includes a respective identifier of the one or more candidate service clusters, to respectively indicate the one or more candidate service clusters.

Access network apparatuses included in the one or more candidate service clusters may be partially the same. For example, each of one or more candidate service clusters may include one or more access network apparatuses (or access nodes), and the one or more access network apparatuses may include a same access network apparatus, for example, the first access network apparatus. In other words, each candidate service cluster may include the first access network apparatus.

For ease of understanding, the following uses an example 1 for description.

The one or more candidate service clusters include a candidate service cluster #1, a candidate service cluster #2, and a candidate service cluster #3. The candidate service cluster #1 includes an access node #1, an access node #2, and an access node #3, the candidate service cluster #2 includes the access node #1, the access node #3, and an access node #4, and the candidate service cluster #3 includes the access node #1, the access node #4, an access node #5, and an access node #6. In this case, an example of the candidate service cluster list may be shown in Table 1.

TABLE 1

| Sequence number | Candidate service cluster list |
|---|---|
| 1 | Candidate service cluster #1 (the access node #1, the access node #2, and the |
| | access node #3) |
| 2 | Candidate service cluster #2 (the access node #1, the access node #3, and the |
| | access node #4) |
| 3 | Candidate service cluster #3 (the access node #1, the access node #4, the |
| | access node #5, and the access node #6) |
| . . . | . . . |

It can be learned that the access node #1 is an access network apparatus included in each of the three candidate service clusters. However, other access nodes included in the three candidate service clusters are different from each other.

Each of the one or more candidate service clusters may be understood as an entity (or an entity set) that can provide a service for a terminal. In other words, the terminal can obtain the service by using the candidate service cluster as a granularity. For example, at least two access network apparatuses included in each candidate service cluster may be configured to jointly provide the service for the terminal, to ensure stability and reliability of the service.

For ease of understanding, the example 1 is still used.

When the candidate service cluster #1 provides a service for a UE #1 (in this case, the candidate service cluster #1 may be referred to as a service cluster #1), if the UE #1 is located in an overlapping area of the access node #1 and the access node #2, the access node #1 and the access node #2 may jointly provide the service for the UE #1. As the UE #1 moves, if the UE #1 moves to an overlapping area of the access node #2 and the access node #3, the access node #2 and the access node #3 may jointly provide the service for the UE #1. The rest can be deduced by analogy. Details are not described again.

Optionally, the candidate service cluster list may further indicate a service condition of the one or more candidate service clusters, for example, a respective service condition of the one or more candidate service clusters, to represent a specific condition that needs to be met for each candidate service cluster to provide the service for the terminal. For example, a service condition of each candidate service cluster may include at least one of the following items: a service area of the candidate service cluster, a communication quality threshold of the candidate service cluster, a preset quantity of terminals of the candidate service cluster, or a preset quantity of resources of the candidate service cluster, indicating that the candidate service cluster can provide the service for the terminal when at least one of the following is met: the service area of the candidate service cluster can cover the terminal, communication quality between the candidate service cluster and the terminal is higher than the communication quality threshold, a quantity of terminals currently served by the candidate service cluster is less than the preset quantity of terminals, or a quantity of currently available resources of the candidate service cluster is greater than the preset quantity of resources. For details, refer to related descriptions of S603. Details are not described herein.

In a possible implementation, the service area of each candidate service cluster may be implicitly represented by using an identifier of an access network apparatus in the candidate service cluster. For example, because the identifier of the access network apparatus corresponds to a service area of the access network apparatus, identifiers of access network apparatuses in each candidate service cluster may be combined to represent a set of service areas of these access network apparatuses, namely, the service area of the candidate service cluster. Alternatively, the service area of each candidate service cluster may be represented in another manner, for example, by using physical location information. This is not specifically limited herein. The service area of each candidate service cluster may be used by the access network apparatus in the candidate service cluster to determine a location relationship between the candidate service cluster and the terminal. If the service area of the candidate service cluster can cover a location of the terminal, it indicates that the service condition is met, and the candidate service cluster can provide the service for the terminal. If the service area of the candidate service cluster cannot cover a location of the terminal, it indicates that the service condition is not met, and the candidate service cluster cannot provide the service for the terminal. In addition, for details about how to determine the location of the terminal, refer to the related descriptions of S603. Details are not described herein.

The communication quality threshold of each candidate service cluster may be an RSRP threshold (or the RSRP threshold may be replaced with a reference signal received quality (reference signal received quality, RSRQ) threshold, a signal to interference plus noise ratio (signal to interference & noise ratio, SINR) threshold, or the like) of the candidate service cluster, in other words, the RSRP threshold between the candidate service cluster and the terminal, or may be represented in another manner. This is not specifically limited herein. The communication quality threshold of each candidate service cluster may represent a communication quality lower limit needed for communication between the candidate service cluster and the terminal. In other words, if the communication quality between the candidate service cluster and the terminal is higher than the communication quality threshold, it indicates that the service condition is met, and the candidate service cluster can provide the service for the terminal. If the communication quality between the candidate service cluster and the terminal is not higher than the communication quality threshold, it indicates that the service condition is not met, and the candidate service cluster cannot provide the service for the terminal.

The preset quantity of terminals of each candidate service cluster may represent an upper limit of a quantity of terminals that can be served by the candidate service cluster. In other words, if the quantity of terminals currently served by the candidate service cluster is less than the preset quantity of terminals, it indicates that the service condition is met, and the candidate service cluster can provide the service for the terminal. If the quantity of terminals currently served by the candidate service cluster is not less than the preset quantity of terminals, it indicates that the service condition is not met, and the candidate service cluster cannot provide the service for the terminal.

The preset quantity of resources of each candidate service cluster may be a preset quantity of resource blocks (RBs) or a preset quantity of resource elements (REs) of the candidate service cluster, or may be a quantity of resources of any other possible granularity. The preset quantity of resources of each candidate service cluster may represent an lower limit of a quantity of resources that can be used by the candidate service cluster to serve the terminal. In other words, if the quantity of currently available resources of the candidate service cluster is greater than the preset quantity of resources, it indicates that the service condition is met, and the candidate service cluster can provide the service for the terminal. If the quantity of currently available resources of the candidate service cluster is not greater than the preset quantity of resources, it indicates that the service condition is not met, and the candidate service cluster cannot provide the service for the terminal.

For ease of understanding, the example 1 is still used.

When the candidate service cluster list indicates the service condition of the one or more candidate service clusters, for example, if a service condition of the candidate service cluster #1 is a service condition #1, a service condition of the candidate service cluster #2 is a service condition #2, and a service condition of the candidate service cluster #3 is a service condition #3, another example of the candidate service cluster list may be shown in Table 2.

TABLE 2

| Sequence number | Candidate service cluster list | Service condition |
|---|---|---|
| 1 | Candidate service cluster #1 (the access node #1, the | Service condition #1 |
| | access node #2, and the access node #3) | |
| 2 | Candidate service cluster #2 (the access node #1, the | Service condition #2 |
| | access node #3, and the access node #4) | |
| 3 | Candidate service cluster #3 (the access node #1, the | Service condition #3 |
| | access node #4, the access node #5, and the access | |
| | node #6) | |
| . . . | . . . | . . . |

It may be understood that, service conditions such as communication quality thresholds, preset quantities of terminals, and preset quantities of resources of any two candidate service clusters may be the same or may be different. For example, the service condition may be configured in correspondence to a priority of the candidate service cluster. For example, a higher priority of a candidate service cluster indicates a looser service condition of the candidate service cluster, for example, a lower communication quality threshold, a larger preset quantity of terminals, or a smaller preset quantity of resources, so that the service conditions can be more easily met and a higher probability of providing the service for the terminal by the candidate service cluster with the higher priority is ensured.

Optionally, the candidate service cluster list may further indicate the priority of the candidate service cluster. For example, a respective priority of the one or more candidate service clusters represents a priority degree of each candidate service cluster for providing the service for the terminal. A higher priority indicates a higher priority degree. The priority of the candidate service cluster may be determined based on service performance of the candidate service cluster. For example, the service performance of the candidate service cluster is represented by at least one of the following items: a communication capacity of the candidate service cluster, a communication rate of the candidate service cluster, or communication quality of the candidate service cluster. For details, refer to the following related descriptions of generating a service cluster set by the management network element. Details are not described herein.

The priority of the one or more candidate service clusters may be implicitly indicated by a sequence of the candidate service clusters in the candidate service cluster list. For example, in the example 1, a sequence of the candidate service cluster #1 to the candidate service cluster #3 is represented by the sequence numbers in Table 1 or Table 2, indicating that the candidate service clusters with priorities in descending order are sequentially the candidate service cluster #1, the candidate service cluster #2, and the candidate service cluster #3. Alternatively, the priority of the one or more candidate service clusters may be explicitly indicated by carrying an additional information element in the candidate service cluster list. For example, an identifier of each candidate service cluster in the candidate service cluster list further corresponds to a priority information element, indicating the priority of the candidate service cluster.

For ease of understanding, the example 1 is still used.

Still another example of the candidate service cluster list may be shown in Table 3.

TABLE 3

| Sequence number | Candidate service cluster list | Service condition | Priority |
|---|---|---|---|
| 1 | Candidate service cluster #1 (the access | Service condition #1 | Priority #1 |
| | node #1, the access node #2, and the | | |
| | access node #3) | | |
| 2 | Candidate service cluster #2 (the access | Service condition #2 | Priority #2 |
| | node #1, the access node #3, and the | | |
| | access node #4) | | |
| 3 | Candidate service cluster #3 (the access | Service condition #3 | Priority #3 |
| | node #1, the access node #4, the access | | |
| | node #5, and the access node #6) | | |
| . . . | . . . | . . . | |

In Table 3, a priority information element corresponding to the candidate service cluster #1 is the priority #1, a priority information element corresponding to the candidate service cluster #2 is the priority #2, and a priority information element corresponding to the candidate service cluster #3 is the priority #3, indicating that the candidate service clusters with priorities in descending order are sequentially the candidate service cluster #1, the candidate service cluster #2, and the candidate service cluster #3.

It may be understood that a service condition and a priority of a candidate service cluster may be jointly used, so that a service cluster that is finally selected to serve the terminal is a service cluster with a highest priority in candidate service clusters that meet service conditions.

The candidate service cluster list may be determined by the management network element based on the service cluster set. For example, the management network element may first generate the service cluster set, and then determine a candidate service cluster from the service cluster set, to obtain the candidate service cluster list.

The service cluster set may be determined by the management network element based on an access network apparatus managed by the management network element. In other words, an access network apparatus included in each service cluster in the service cluster set may be an access network apparatus managed by the management network element. Because the candidate service cluster is determined from the service cluster set, a definition of the service cluster set may be understood as being similar to a definition of the candidate service cluster. In other words, access network apparatuses included in the service cluster set may be partially the same. For example, each service cluster in the service cluster set may include one or more access network apparatuses, and the one or more access network apparatuses may include a same access network apparatus, for example, the first access network apparatus. In other words, each service cluster may include the first access network apparatus.

It may be understood that, because each service cluster in the service cluster set includes the first access network apparatus, it indicates that the management network element determines the service cluster set with the first access network apparatus as a head base station (or a head access network apparatus). The head base station is mainly responsible for determining a service cluster and managing the service cluster. For details, refer to the following related descriptions. Details are not described herein.

Manner 1: The management network element may determine, based on a request of the first access network apparatus, the service cluster set with the first access network apparatus as the head base station.

Specifically, the first access network apparatus may send a candidate service cluster list request to the management network element based on information from the first terminal.

The first terminal may be a terminal that accesses the first access network apparatus, and there may be one or more first terminals. This is not limited herein. The information from the first terminal may include at least one of the following items: representing that the first terminal successfully accesses the first access network apparatus, a measurement result of a downlink channel between the first access network apparatus and the first terminal, or the information from the first terminal being an uplink reference signal sent by the first terminal, for example, an SRS. In other words, the first terminal may send the information to the first access network apparatus at any possible occasion, for example, when the access succeeds, when downlink measurement is completed, or when uplink measurement starts, to trigger a service provided by a service cluster for the first terminal. A specific occasion is selected based on an actual situation. This is not limited in this embodiment of this application.

The candidate service cluster list request may be an existing message, or may be a newly defined message, and is used by the first access network apparatus to request the management network element to allocate the candidate service cluster list. For example, the candidate service cluster list request may include an identifier of the first access network apparatus, and optionally, may further include a first information element. The identifier of the first access network apparatus may uniquely identify the first access network apparatus. The first information element may be used to request the management network element to allocate the candidate service cluster list. The first information element and the first information element may be combined to indicate that the first access network apparatus requests the management network element to allocate the candidate service cluster list. In addition, when there is no first information element, that the first access network apparatus requests the management network element to allocate the candidate service cluster list may be represented in another manner, for example, implicitly represented by using a message type of the candidate service cluster list request.

The first access network apparatus may be triggered, based on the information from the first terminal, to determine whether there is a candidate service cluster that can provide the service for the first access network apparatus. For example, the first access network apparatus may determine whether there is the candidate service cluster list. If there is no candidate service cluster list, it indicates that the first access network apparatus has not obtained the candidate service cluster list from the management network element in advance. In this way, the first access network apparatus determines that the candidate service cluster list needs to be requested from the management network element, so that the first access network apparatus sends the candidate service cluster list request to the management network element. If there is the candidate service cluster list, it indicates that the first access network apparatus has obtained the candidate service cluster list from the management network element in advance. In this way, in one case, the first access network apparatus may directly determine that the candidate service cluster list does not need to be requested from the management network element, and directly use the candidate service cluster list to serve the first terminal. Alternatively, in another case, the first access network apparatus may further determine whether the candidate service cluster list is valid, for example, determine whether a timer configured for the candidate service cluster list expires. If the timer does not expire, it indicates that the candidate service cluster list is valid, and the first access network apparatus may still directly use the candidate service cluster list to serve the first terminal. If the timer expires, it indicates that the candidate service cluster list is invalid, and the first access network apparatus determines that there is a need to request the management network element to configure a new candidate service cluster list, so that the first access network apparatus sends the candidate service cluster list request to the management network element.

It may be understood that, because the terminal triggers the first access network apparatus to request the candidate service cluster list from the management network element, to implement that movement of the terminal triggers delivery of a candidate service cluster list matching the location of the terminal, it is ensured that a service obtained by a user in real time is good.

The management network element may receive the candidate service cluster list request from the first access network apparatus, and generate the candidate service cluster list based on the candidate service cluster list request. For example, the management network element may determine a location of the first access network apparatus based on the identifier of the first access network apparatus, to separately combine access network apparatuses near the first access network apparatus with the first access network apparatus to form different service clusters, thereby obtaining the service cluster set.

The management network element may evaluate service performance of each service cluster in the service cluster set. For example, service performance of any service cluster in the service cluster set may be represented by using at least one of the following items: a communication capacity of the service cluster, a communication rate of the service cluster, or communication quality of the service cluster. The communication capacity of the service cluster, the communication rate of the service cluster, or the communication quality of the service cluster may be determined by the management network element based on channel quality reported by an access network apparatus in the service cluster. The communication capacity is used as an example (where reference may be made for understanding of the other indicators). The management network element may determine the communication capacity by using the following formula 1 and formula 2:

$${C}_{j} = E [ \frac{1}{{L}_{j}} log det ( I + P {\tilde{H}}_{j} {\tilde{H}}_{j}^{H} ) ] ; and \qquad ( 1 )$$

$${\tilde{H}}_{j} = {( {N}_{0} I + \sum j )}^{- \frac{1}{2}} {H}_{j} . \qquad ( 2 )$$

The service cluster set includes M service clusters, Cⱼ is a communication capacity of a j^{th} service cluster, M is an integer greater than 1, j is an integer ranging from 1 to M, E is an averaging operation, L, is a quantity of access network apparatuses in the j^{th} service cluster, I is a unit matrix, P is transmit power of a terminal in the j^{th} service cluster, Hⱼ is channel quality or a channel gain in the j^{th} service cluster, Hⱼ is determined by the management network element based on channel quality reported by the access network apparatuses in the j^{th} service cluster, Σj is a sum of interference from another service cluster that is other than the j^{th} service cluster and that is in the M service clusters on the j^{th} service cluster, and N₀ is noise power.

It may be learned that a communication capacity of each service cluster may represent a maximum communication rate that can be theoretically reached by the service cluster. A larger communication capacity indicates a larger maximum communication rate and better service performance of the service cluster. A communication rate of each service cluster may represent a speed of data transmission between a terminal in the service cluster and an access network apparatus in the service cluster. A higher speed of data transmission indicates better service performance. Communication quality of each service cluster may represent signal quality between a terminal in the service cluster and an access network apparatus in the service cluster, for example, reference signal received power. Better signal quality indicates better service performance.

The management network element may determine a service cluster whose service performance is higher than preset service performance in the service cluster set as a candidate service cluster, to obtain the candidate service cluster list. In other words, the service cluster in the candidate service cluster list may be the service cluster whose service performance is higher than the preset service performance in the service cluster set. For example, the management network element may perform averaging, weighted averaging, or weighted summation on at least one of the communication capacity, the communication rate, and the communication quality of each service cluster, to obtain an actual value (an average value and/or another value) representing the service performance of the service cluster. The management network element may compare the actual value of each service cluster with a preset value. If the actual value of the service cluster is greater than the preset value, the service performance of the service cluster is higher than the preset service performance, and the management network element determines the service cluster as a candidate service cluster. If the actual value of the service cluster is not greater than the preset value, the management network element ignores the service cluster. For another example, the management network element may alternatively compare at least one of the actual communication capacity, communication rate, and communication quality of each service cluster with a corresponding preset value. If each of the at least one item is greater than the preset value, it indicates that the service performance of the service cluster is higher than the preset service performance, and the management network element determines the service cluster as a candidate service cluster. If each of the at least one item is not greater than the preset value, the management network element ignores the service cluster. In this way, the management network element may generate, based on the foregoing determined candidate service cluster, the candidate service cluster list indicating the candidate service cluster.

For ease of understanding, the foregoing example is still used.

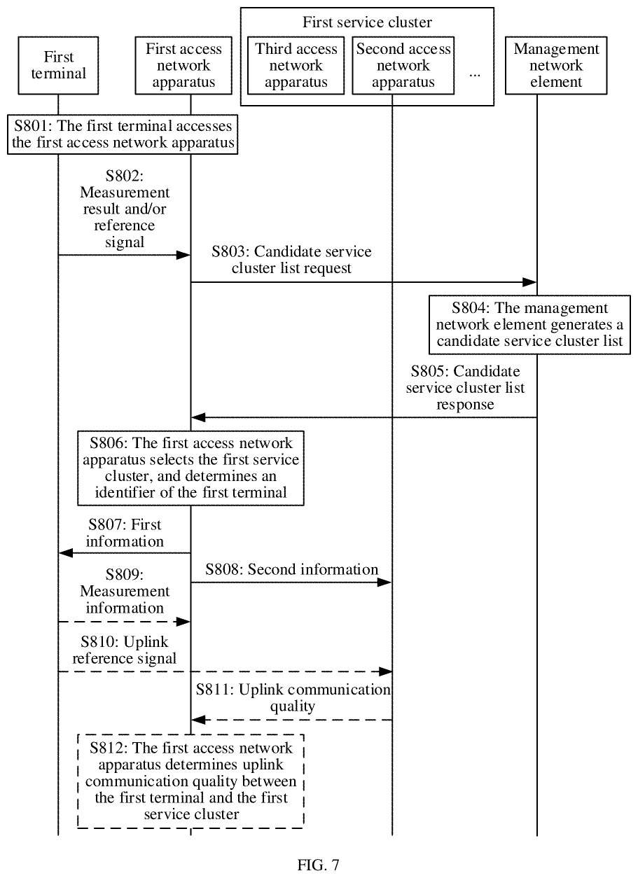

As shown in FIG. 6, an access node #1 to an access node #14 are all managed by the management network element. After accessing the access node #1, the UE #1 triggers the access node #1 to send the candidate service cluster list request to the management network element. The management network element determines a location of the access node #1 based on the candidate service cluster list request, and determines that access nodes located near the access node #1 include the access node #2 to the access node #7. In this case, the access node #8 to the access node #14 are far away from the access node #1 and are not considered. The management network element separately combines the access node #2 to the access node #7 with the access node #1 to form different service clusters, to obtain a service cluster set including a service cluster #1, a service cluster #2, a service cluster #3, a service cluster #4, a service cluster #5, a service cluster #6, and a service cluster #7.

The service cluster #1 includes the access node #1, the access node #2, and the access node #3. The service cluster #2 includes the access node #1, the access node #3, and the access node #4. The service cluster #3 includes the access node #1, the access node #4, the access node #5, and the access node #6. The service cluster #4 includes the access node #1 and the access node #2. The service cluster #5 includes the access node #1 and the access node #3. The service cluster #6 includes the access node #1 and the access node #4. The service cluster #7 includes the access node #1, the access node #4, the access node #5, the access node #6, and the access node #7.

The management network element may determine respective service performance of the service cluster #1 to the service cluster #7, and compare the service performance with preset service performance. In this case, the service performance of the service cluster #1 to the service cluster #3 is all higher than the preset service performance, and the service performance of the service cluster #4 to the service cluster #7 is all less than or equal to the preset service performance. Therefore, the management network element determines the service cluster #1 to the service cluster #3 as candidate service clusters, namely, the foregoing candidate service cluster #1, candidate service cluster #2, and candidate service cluster #3, to generate the candidate service cluster list, as shown in Table 1.

It may be understood that the foregoing determining the candidate service cluster list by using the service performance is merely an example rather than a limitation. For example, the management network element may alternatively randomly determine a service cluster in the service cluster set as a candidate service cluster, to obtain the candidate service cluster list. For another example, the management network element may alternatively select, in ascending or descending order of quantities of access network apparatuses included in all service clusters, a preset quantity of service clusters as candidate service clusters, to obtain the candidate service cluster list. For still another example, the management network element may alternatively determine the candidate service cluster list in any other possible manner. This is not limited in this embodiment of this application.

Manner 2: The management network element may autonomously determine the service cluster set with the first access network apparatus as the head base station.

Specifically, the management network element may autonomously use the first access network apparatus as the head base station. Details about how the management network element performs determining are not limited in this embodiment of this application. In other words, a network side (the management network element) may actively update the candidate service cluster list, to ensure that performance of each service cluster is good. For example, the management network element is configured with a timer. When the timer expires, it indicates that a current periodicity ends, and the management network element is triggered to determine a service cluster set of a next periodicity, and select a candidate service cluster from the service cluster set, to obtain a candidate service cluster list of the next periodicity. The management network element may further reset the timer when the timer expires, to perform timing on the next periodicity, so that when the next periodicity ends, the management network element is still triggered to iteratively perform the foregoing procedure.

It may be understood that a specific implementation principle of determining, by the management network element, a service cluster set and a candidate service cluster list of each periodicity is similar to the foregoing first possible implementation. Reference may be made for understanding. Details are not described herein again.

Optionally, when the service condition of the candidate service cluster needs to be indicated, the management network element may further allocate a corresponding service condition to each candidate service cluster, for example, allocate the corresponding service condition to each candidate service cluster based on the priority of the candidate service cluster, to generate the candidate service cluster list indicating the service condition, as shown in Table 2. Optionally, when the priority of the candidate service cluster needs to be indicated, the management network element may further determine the priority of the candidate service cluster based on service quality of each candidate service cluster, to generate the candidate service cluster list that can explicitly or implicitly indicate the priority, as shown in Table 3.

It may be further understood that the foregoing uses the first access network apparatus as an example rather than a limitation. The first access network apparatus may alternatively be replaced with any other possible access network apparatus managed by the management network element.

S602: The management network element sends the candidate service cluster list to the first access network apparatus. The first access network apparatus receives the candidate service cluster list.

For the foregoing manner 1, the management network element may send, to the first access network apparatus in response to the candidate service cluster list request sent by the first access network apparatus, a candidate service cluster list response carrying the candidate service cluster list.

For the foregoing manner 2, the management network element may periodically send the candidate service cluster list to the first access network apparatus. For example, when the candidate service cluster list is generated in each periodicity, the management network element sends, to the first access network apparatus, a message carrying the candidate service cluster list, for example, a candidate service cluster list notification, or any other possible message. This is not limited herein.

S603: The first access network apparatus sends first information to the first terminal based on the candidate service cluster list, and the first terminal receives the first information from the first access network apparatus.

The first information may indicate that a first service cluster serves the first terminal.

The first service cluster may be a service cluster in the one or more candidate service clusters. For example, after receiving the candidate service cluster list, the first access network apparatus may select, from the candidate service cluster list, a candidate service cluster suitable for providing a service for the first terminal, namely, the first service cluster. The first access network apparatus may select the first service cluster in a plurality of manners, which are separately described below.

Manner A: The first access network apparatus may randomly select, as the first service cluster, one candidate service cluster from the one or more candidate service clusters indicated by the candidate service cluster list.

For ease of understanding, the foregoing example is still used.

As shown in Table 1, the access node #1 may randomly select the candidate service cluster #1 from the candidate service cluster #1, the candidate service cluster #2, and the candidate service cluster #3 as the first service cluster based on the candidate service cluster list.

Manner B: When the candidate service cluster list indicates the service condition of the one or more candidate service clusters, the first service cluster may be a service cluster that meets a service condition, to ensure that the first service cluster can provide a good service for the first terminal.

The first access network apparatus may obtain, based on the one or more candidate service clusters indicated by the candidate service cluster list, information about at least one of the following items of each candidate service cluster: the service area of the candidate service cluster, the current communication quality between the candidate service cluster and the terminal, the quantity of terminals currently served by the candidate service cluster, or the quantity of currently available resources of the candidate service cluster.

For example, a candidate service cluster (denoted as a first candidate service cluster) is used as an example.

The first access network apparatus may obtain, from an access network apparatus (denoted as another access network apparatus) other than the first access network apparatus in the first candidate service cluster, at least one of the following items: a service area of the another access network apparatus, current communication quality between the another access network apparatus and a terminal, a quantity of terminals currently served by the another access network apparatus, or a quantity of currently available resources of the another access network apparatus. In this way, the first access network apparatus may superimpose the service area of the first access network apparatus and a service area of an access network apparatus in a neighboring cell, to obtain a service area of the first candidate service cluster. The first access network apparatus may alternatively perform weighted summation or weighted averaging on the current communication quality between the first access network apparatus and the terminal and the current communication quality between the another access network apparatus and the terminal, to obtain current communication quality between the first candidate service cluster and the terminal. The first access network apparatus may alternatively add the quantity of terminals currently served by the first access network apparatus and the quantity of terminals currently served by the another access network apparatus, to obtain a quantity of terminals currently served by the first candidate service cluster. The first access network apparatus may alternatively add the quantity of currently available resources of the first access network apparatus and the quantity of currently available resources of the another access network apparatus, to obtain a quantity of currently available resources of the first candidate service cluster.

In a possible implementation, for an access network apparatus that is in the another access network apparatus and that currently cannot serve the first terminal, the first access network apparatus may set, in the foregoing process of weighted summation or weighted averaging, a weight value corresponding to the access network apparatus to a small value, for example, 0.1 or 0.05, or may directly set the weight value to 0.

The first access network apparatus may determine, based on at least one of the foregoing information about each candidate service cluster and the service condition of the candidate service cluster, a candidate service cluster that meets a service condition. That the candidate service cluster meets the service condition may include at least one of the following items: A service area of the candidate service cluster covers a location of a terminal, current communication quality between the candidate service cluster and the terminal is higher than a communication quality threshold, a quantity of terminals currently served by the candidate service cluster is less than a preset quantity of terminals, or a quantity of currently available resources of the candidate service cluster is greater than a preset quantity of resources.

The location of the terminal may be a location to which the terminal may move. For example, the first access network apparatus may predict, based on a current location of the terminal and a current movement direction of the terminal, the location to which the terminal may move. In this case, the first access network apparatus may select, from the one or more candidate service clusters, a candidate service cluster in which a service area of an access network apparatus (for example, an access network apparatus other than the first access network apparatus in the candidate service cluster) in the candidate service cluster can cover at least a part or all of the location to which the terminal may move, to reduce a quantity of handovers of the terminal, and avoid performance deterioration caused by frequent handovers. That the current communication quality between the candidate service cluster and the terminal is higher than the communication quality threshold may be understood as that the current communication quality between the candidate service cluster and the terminal is good, to avoid that service quality cannot be ensured due to poor communication quality. That the quantity of terminals currently served by the candidate service cluster is less than the preset quantity of terminals may be understood as that the quantity of terminals currently served by the candidate service cluster is small, to avoid service congestion caused by an excessive quantity of terminals, thereby ensuring the service quality. That the quantity of currently available resources of the candidate service cluster is greater than the preset quantity of resources may be understood as that the quantity of currently available resources of the candidate service cluster is sufficient, to avoid that the service quality cannot be ensured due to insufficient available resources.

In this case, if there is one candidate service cluster that meets a service condition, the first access network apparatus may use the candidate service cluster as the first service cluster. Alternatively, if there are a plurality of candidate service clusters that meet service conditions, the first access network apparatus may select one candidate service cluster from the one or more candidate service clusters as the first service cluster.

It may be understood that, because the first service cluster is a service cluster selected from the candidate service clusters that meet the service conditions, the first service cluster also meets a service condition, for example, including at least one of the following items: A service area of the first service cluster covers a location of a terminal, current communication quality between the first service cluster and the terminal is higher than a communication quality threshold, a quantity of terminals currently served by the first service cluster is less than a preset quantity of terminals, or a quantity of currently available resources of the first service cluster is greater than a preset quantity of resources.

For ease of understanding, the foregoing example is still used.

As shown in Table 2, the access node #1 may obtain, from the access node #2 and the access node #3 in the candidate service cluster #1, information about the access node #2 and information about the access node #3 based on the candidate service cluster list. The access node #1 may also obtain, from the access node #4 in the candidate service cluster #2, information about the access node #4 based on the candidate service cluster list. The access node #1 may further obtain, from the access node #5 and the access node #6 in the candidate service cluster #3, information about the access node #5 and information about the access node #6 based on the candidate service cluster list.

The access node #1 may determine information about the candidate service cluster #1 based on the information about the access node #1, the information about the access node #2, and the information about the access node #3. For example, a service area of the access node #1 is an area #1, a service area of the access node #2 is an area #2, a service area of the access node #3 is an area #3, and a service area of the candidate service cluster #1 is an area obtained by superimposing the area #1, the area #2, and the area #3. For another example, communication quality between the access node #1 and 10 UEs corresponds to RSRP #1 to RSRP #10, communication quality between the access node #2 and 10 UEs corresponds to RSRP #11 to RSRP #20, and communication quality between the access node #3 and 20 UEs corresponds to RSRP #21 to RSRP #40. In this case, communication quality between the candidate service cluster #1 and these UEs may be weighted average RSRP of the 40 pieces of RSRP (the RSRP #1 to the RSRP #40). For still another example, a quantity of UEs currently served by the access node #1 is 10, for example, the UE #1 to a UE #10, a quantity of UEs currently served by the access node #2 is also 10, for example, a UE #11 to a UE #20, and a quantity of UEs currently served by the access node #3 is 20, for example, a UE #21 to a UE #40. In this case, a quantity of UEs currently served by the candidate service cluster #1 is a total quantity of UEs currently served by the access node #1 to the access node #3, namely, the 40 UEs, for example, the UE #1 to the UE #40. For yet another example, a quantity of currently available resources of the access node #1 is 100 RBs, a quantity of currently available resources of the access node #2 is also 100 RBs, and a quantity of currently available resources of the access node #3 is 200 RBs. In this case, a quantity of currently available resources of the candidate service cluster #1 is a total quantity of currently available resources of the access node #1 to the access node #3, namely, 400 RBs.

Similarly, the access node #1 may determine information about the candidate service cluster #2 based on the information about the access node #1, the information about the access node #3, and the information about the access node #4. In addition, the access node #1 may further determine information about the candidate service cluster #3 based on the information about the access node #1, the information about the access node #4, the information about the access node #5, and the information about the access node #6. A specific principle is similar to that of determining the information about the candidate service cluster #1. Reference may be made for understanding. Details are not described herein again.

The access node #1 may determine, based on the information about the candidate service cluster #1 and the service condition of the candidate service cluster #1, that the candidate service cluster #1 meets the service condition. The access node #1 may determine, based on the information about the candidate service cluster #2 and the service condition of the candidate service cluster #2, that the candidate service cluster #2 also meets the service condition. The access node #3 may determine, based on the information about the candidate service cluster #3 and the service condition of the candidate service cluster #3, that the candidate service cluster #3 does not meet the service condition. In this way, there are two candidate service clusters that meet service conditions: the candidate service cluster #1 and the candidate service cluster #2. The access node #1 may randomly select a candidate service cluster as the first service cluster, denoted as a service cluster #1. For example, the candidate service cluster #1 is selected as the service cluster #1.

Manner C: When the candidate service cluster list further indicates the service condition and the priority of the one or more candidate service clusters, the first service cluster may be a service cluster with a highest priority in candidate service clusters that meet service conditions. A priority of a service cluster may be determined based on service performance between the service cluster and a terminal. A better service performance indicates a higher priority. In this way, a service cluster is selected in descending order of priorities, so that it can be ensured that a finally selected service cluster, for example, the first service cluster, is a service cluster that can provide a stable and reliable service for the first terminal, thereby ensuring service quality.

For ease of understanding, the foregoing example is still used.

As shown in Table 3, there are two candidate service clusters that meet service conditions: the candidate service cluster #1 and the candidate service cluster #2. The access node #1 may perform selection based on priorities. For example, the priority of the candidate service cluster #1 is higher than the priority of the candidate service cluster #2, so that the access node #1 selects the candidate service cluster #1 as the service cluster #1.

In this embodiment of this application, the first information may include at least one of the following items: an identifier of the first service cluster, an identifier of the first terminal, or an identifier of an access network apparatus included in the first service cluster. The identifier of the first service cluster may be an identifier of a candidate service cluster (the same service cluster) that is in the candidate service cluster list and that is used as the first service cluster. The identifier of the first terminal may be an identifier allocated by the first access network apparatus to the first terminal, and is used to uniquely identify the first terminal in the first service cluster. The identifier of the first terminal may be a newly defined identifier, for example, CuID, clusterID, or any other possible name, or the identifier of the first terminal may be implemented by reusing an existing identifier. This is not specifically limited herein. The identifier of the access network apparatus included in the first service cluster may be an identifier of each access network apparatus included in the first service cluster, and is used to uniquely identify each access network apparatus.

For ease of understanding, the foregoing example is still used.

The access node #1 may send information about the service cluster #1 to the UE #1, for example, CuID #1 of the UE #1 in the service cluster #1, an identifier of the service cluster #1, an identifier of the access node #1, an identifier of the access node #2, and an identifier of the access node #3.

It may be understood that, if the first access network apparatus is triggered to obtain the candidate service cluster list based on the information from the first terminal, after obtaining the candidate service cluster list, the first access network apparatus may directly send the first information to the first terminal. Alternatively, if the first access network apparatus periodically obtains the candidate service cluster list, the first access network apparatus may be triggered, based on the received information from the first terminal, to send the first information to the first terminal. For example, the first access network apparatus sends, in response to the information from the first terminal, the first information to the first terminal based on the candidate service cluster list. In other words, the terminal triggers the first access network apparatus to send the first information to the terminal, and it is not that the first access network apparatus may send information to the terminal at any occasion, to avoid unnecessary overheads caused by frequent information sending.

In this embodiment of this application, the first access network apparatus may further send second information to another access network apparatus other than the first access network apparatus in the first service cluster. For example, the another access network apparatus other than the first access network apparatus in the first service cluster is a second access network apparatus. The first access network apparatus may further send the second information to the second access network apparatus.

The second information may indicate information about the first service cluster. For example, the information about the first service cluster includes at least one of the following items: the identifier of the first service cluster, an identifier of a terminal served by the first service cluster (including the identifier of the first terminal), or the identifier of the first access network apparatus, to indicate that the first access network apparatus is a head base station in the first service cluster, and that the second access network apparatus, as an access network apparatus in the first service cluster, needs to provide a service for the terminal served by the first service cluster.

In this way, the first terminal can be aligned with the access network apparatus in the first service cluster, in other words, the first terminal can learn of a specific access network apparatus that can provide a service for the first terminal, and the access network apparatus in the first service cluster can also learn of a specific terminal that can be served by the access network apparatus, so that the first terminal can communicate with the first service cluster, in other words, perform the following S604.

S604: The first terminal communicates with the first service cluster based on the first information.

The first terminal may complete downlink measurement or uplink measurement with the first service cluster based on the first information. Details are separately described below.

### (1) Downlink Measurement:

The first terminal may send measurement information to the first service cluster based on the first information.

The measurement information may indicate communication quality between the first terminal and the first service cluster, for example, downlink communication quality, and may be specifically represented by using RSRP, RSRQ, an SINR, or the like. The measurement information may be information determined based on respective communication quality between the first terminal and at least one access network apparatus in the first service cluster. For example, the first terminal may receive a respective reference signal (for example, a downlink reference signal) of the at least one access network apparatus in the first service cluster, to determine respective downlink communication quality between the first terminal and the at least one access network apparatus, where there is at least one piece of downlink communication quality in total. In this way, the first terminal may perform weighted summation on the at least one piece of downlink communication quality, to obtain the downlink communication quality between the first terminal and the first service cluster. In addition, the measurement information may further include the identifier of the first service cluster, to explicitly indicate the first service cluster, or the measurement information may implicitly indicate the first service cluster in another manner, for example, based on an information type. This is not specifically limited herein.

It may be understood that, when the first terminal can comprehensively evaluate the downlink communication quality between the first terminal and the first service cluster, the first terminal may directly send the measurement information of the first service cluster to the head base station (for example, the first access network apparatus) in the first service cluster. In this way, in comparison with a case in which the first terminal separately sends the measurement information to an access network apparatus other than the first access network apparatus in the first service cluster, and then the access network apparatus forwards the measurement information to the first access network apparatus, overheads may be reduced, and communication efficiency may be improved. It is clear that, if the first terminal does not comprehensively evaluate the communication quality between the first terminal and the first service cluster, for example, only the respective downlink communication quality between the first terminal and the at least one access network apparatus in the first service cluster is determined, the first terminal may separately send, to the at least one access network apparatus, respective downlink communication quality corresponding to the at least one access network apparatus, and the at least one access network apparatus forwards, to the head base station (for example, the first access network apparatus) in the first service cluster, the respective downlink communication quality corresponding to the at least one access network apparatus, so that the first access network apparatus can comprehensively evaluate the downlink communication quality between the first terminal and the first service cluster, to perform mobility management on a user and ensure a user rate.

For ease of understanding, the foregoing example is still used.

The UE #1 may receive a downlink reference signal #1 from the access node #1, to determine RSRP #A between the UE #1 and the access node #1 based on the downlink reference signal #1. The UE #1 may also receive a downlink reference signal #2 from the access node #2, to determine RSRP #B between the UE #1 and the access node #2 based on the downlink reference signal #2. The UE #1 may further receive a downlink reference signal #3 from the access node #3, to determine RSRP #C between the UE #1 and the access node #3 based on the downlink reference signal #3. In this way, the UE #1 may perform weighted summation on the RSRP #A, the RSRP #B, and the RSRP #C, to determine downlink communication quality between the UE #1 and the service cluster #1 and report the downlink communication quality to the access node #1.

### (2) Uplink Measurement:

The first terminal may send a reference signal to the first service cluster based on the first information.

The reference signal (for example, an uplink reference signal) may be used for the communication quality, for example, uplink communication quality, between the first terminal and the first service cluster.

For at least one access network apparatus, for example, the second access network apparatus, that receives the reference signal in the first service cluster, the second access network apparatus may determine, based on an identifier that is of an access network apparatus in the first service cluster and that is carried in the reference signal matching an identifier of the second access network apparatus, that the reference signal is a signal sent to the second access network apparatus. Because the second access network apparatus has received at least one piece of the following information in S603 in advance: the identifier of the first service cluster, the identifier of the first terminal, or the identifier of the first access network apparatus, the second access network apparatus may match the identifier of the first service cluster and/or the identifier of the first terminal in the reference signal with the at least one piece of information, to determine that the first terminal is a terminal in the first service cluster. In this way, the second access network apparatus may determine uplink communication quality between the first terminal and the second access network apparatus based on the reference signal, and send the uplink communication quality to the head base station (for example, the second access network apparatus) in the first service cluster. Correspondingly, the first access network apparatus may receive respective uplink communication quality that is between the at least one access network apparatus and the first terminal and that is sent by the at least one access network apparatus, and there is at least one piece of uplink communication quality in total. The first access network apparatus may perform weighted summation on the at least one piece of uplink communication quality, to obtain the uplink communication quality between the first terminal and the first service cluster, so that mobility management is performed on a user, and a user-perceived rate is ensured.

For ease of understanding, the foregoing example is still used.

The UE #1 may send an uplink reference signal #1 to the access node #1, so that the access node #1 determines RSRP #D between the UE #1 and the access node #1 based on the uplink reference signal #1. The UE #1 may also send an uplink reference signal #2 to the access node #2, so that the access node #2 determines RSRP #E between the UE #1 and the access node #2 based on the uplink reference signal #2, and sends the RSRP #E to the access node #1. The UE #1 may further send an uplink reference signal #3 to the access node #3, so that the access node #3 determines RSRP #F between the UE #1 and the access node #3 based on the uplink reference signal #3, and sends the RSRP #F to the access node #1. In this way, the access node #1 may perform weighted summation on the RSRP #D, the RSRP #E, and the RSRP #F, to determine uplink communication quality between the UE #1 and the service cluster #1.

It may be understood that a function implemented by the first access network apparatus is a function of the head base station in the first service cluster. Reference may be made for understanding of a function of a head base station in another service cluster. Details are not described herein again.

In conclusion, one or more different candidate service clusters are dynamically configured around a same access network apparatus, for example, the first access network apparatus, so that the first access network apparatus can select a service cluster suitable for a current actual situation, for example, the first service cluster, to provide a service for a first apparatus that accesses the first access network apparatus. This further improves user experience.

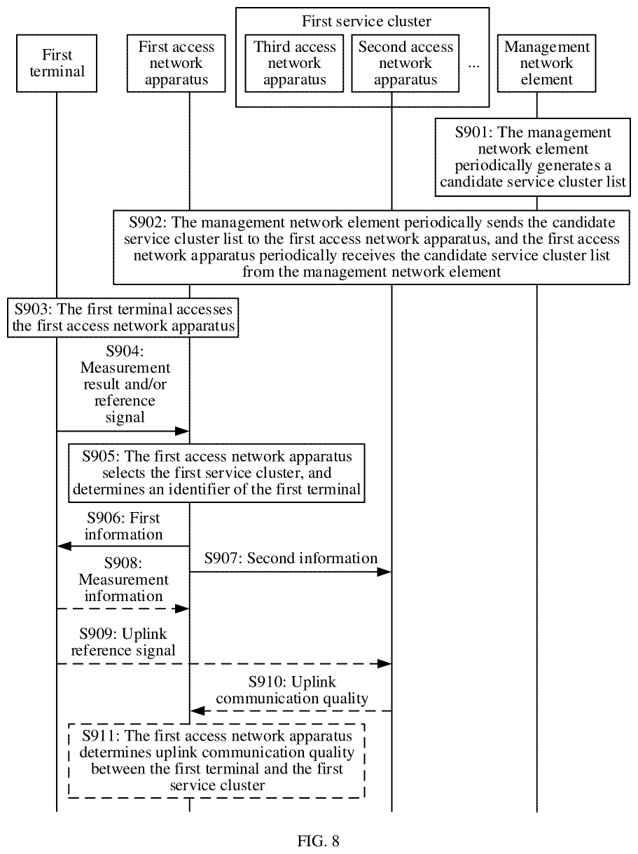

The foregoing describes in detail an overall procedure of the communication method provided in embodiments of this application with reference to FIG. 5 and FIG. 6. The following describes in detail procedures of performing communication methods provided in embodiments of this application in specific scenarios with reference to FIG. 7 and FIG. 8.

FIG. 7 is a schematic flowchart 2 of a communication method according to an embodiment of this application. The communication method is applicable to the foregoing communication system, and mainly relates to interaction between a first terminal, a first access network apparatus, a second access network apparatus, and a management network element.

Specifically, as shown in FIG. 7, a procedure of the communication method is shown below.

S801: The first terminal accesses the first access network apparatus.

The first terminal may access the first access network apparatus in a random access manner. For a specific principle, refer to descriptions in a related protocol. Details are not described herein.

S802: The first terminal sends a measurement result and/or a reference signal to the first access network apparatus. The first access network apparatus receives the measurement result and/or the reference signal from the first terminal.

The measurement result may be a measurement result of a downlink channel between the first terminal and the first access network apparatus. The reference signal may be an uplink reference signal, and is used by the first access network apparatus to measure an uplink channel between the first terminal and the first access network apparatus. For a specific principle, refer to related descriptions of S601. Details are not described herein again.

S803: The first access network apparatus sends a candidate service cluster list request to the management network element. The management network element receives the candidate service cluster list request from the first access network apparatus.

If the first access network apparatus has not obtained a candidate service cluster list in advance, or a candidate service cluster list obtained in advance is aged, the first access network apparatus may be triggered, based on the measurement result and/or the reference signal, to send the candidate service cluster list request to the management network element, to request to obtain the candidate service cluster list. For a specific principle, refer to the related descriptions of S601. Details are not described herein again.

If the first access network apparatus has obtained a candidate service cluster list in advance, and the candidate service cluster list is not aged, the first access network apparatus may be triggered, based on the measurement result and/or the reference signal, to perform the following S806. In other words, S803 to S805 are skipped.

S804: The management network element generates the candidate service cluster list.

A candidate service cluster in the candidate service cluster list may be a service cluster in which the first access network apparatus is used as a head base station. For a specific principle, refer to the related descriptions of S601. Details are not described herein again.

S805: The management network element sends a candidate service cluster list response to the first access network apparatus. The first access network apparatus receives the candidate service cluster list response from the management network element.

The candidate service cluster list response may carry the foregoing candidate service cluster list. For a specific principle, refer to related descriptions of S602. Details are not described herein again.

S806: The first access network apparatus selects a first service cluster, and determines an identifier of the first terminal.

The first service cluster may be a service cluster indicated in the candidate service cluster list, may include at least the first access network apparatus and the second access network apparatus, and may further include more access node apparatuses. This is not specifically limited herein. Optionally, the first access network apparatus may further allocate the identifier of the first terminal to the first terminal, to uniquely identify the first terminal in the first service cluster. Alternatively, the first terminal may continue to use an existing ID of the first terminal, for example, a subscription permanent identifier (SUPI).

In addition, for a specific principle of S806, refer to related descriptions of S603. Details are not described herein again.
S807: The first access network apparatus sends first information to the first terminal.
S808: The first access network apparatus sends second information to the second access network apparatus.

For specific principles of the first information and the second information, refer to the related descriptions of S603. Details are not described herein again.

It may be understood that the second access network apparatus is used as an example in this embodiment of this application. If the first service cluster further includes another access node apparatus, for example, a third access node apparatus, the first access network apparatus may still send the second information to the access node apparatus. In addition, an execution sequence between S807 and S808 is not limited.
S809: The first terminal sends measurement information to the first access network apparatus.

For a specific principle of S809, refer to related descriptions of downlink measurement in S604. Details are not described herein again.
S810: The first terminal separately sends an uplink reference signal to the first access network apparatus and the second access network apparatus.
S811: The second access network apparatus sends uplink communication quality to the first access network apparatus.
S812: The first access network apparatus determines uplink communication quality between the first terminal and the first service cluster.

For a specific principle of S810 to S812, refer to related descriptions of uplink measurement in S604. Details are not described herein again.

It may be understood that an execution sequence between S809 and S810 to S812 is not limited, and S809 or S810 to S812 are optional steps, and may not be actually performed.

FIG. 8 is a schematic flowchart 3 of a communication method according to an embodiment of this application. The communication method is applicable to the foregoing communication system, and mainly relates to interaction between a first terminal, a first access network apparatus, a second access network apparatus, and a management network element.

Specifically, as shown in FIG. 8, a procedure of the communication method is shown below.

S901: The management network element periodically generates a candidate service cluster list.

A candidate service cluster in the candidate service cluster list may be a service cluster in which the first access network apparatus is used as a head base station. For a specific principle, refer to related descriptions of S601. Details are not described herein again.

S902: The management network element periodically sends the candidate service cluster list to the first access network apparatus, and the first access network apparatus periodically receives the candidate service cluster list from the management network element.

The candidate service cluster list may be carried in a candidate service cluster list notification. For a specific principle, refer to related descriptions of S602. Details are not described herein again.

S903: The first terminal accesses the first access network apparatus.

The first terminal may access the first access network apparatus in a random access manner. For a specific principle, refer to descriptions in a related protocol. Details are not described herein.

S904: The first terminal sends a measurement result and/or a reference signal to the first access network apparatus. The first access network apparatus receives the measurement result and/or the reference signal from the first terminal.

The measurement result may be a measurement result of a downlink channel between the first terminal and the first access network apparatus. The reference signal may be an uplink reference signal, and is used by the first access network apparatus to measure an uplink channel between the first terminal and the first access network apparatus. For a specific principle, refer to the related descriptions of S601. Details are not described herein again.

S905: The first access network apparatus selects a first service cluster, and determines an identifier of the first terminal.

The first service cluster may be a service cluster indicated in the candidate service cluster list, may include at least the first access network apparatus and the second access network apparatus, and may further include more access node apparatuses. This is not specifically limited herein.

The first access network apparatus may be triggered, based on the measurement result and/or the reference signal, to select the first service cluster from the candidate service cluster list. In addition, optionally, the first access network apparatus may further allocate the identifier of the first terminal to the first terminal, to uniquely identify the first terminal in the first service cluster. Alternatively, the first terminal may continue to use an existing ID of the first terminal.

In addition, for a specific principle of S905, refer to related descriptions of S603. Details are not described herein again.
S906: The first access network apparatus sends first information to the first terminal.
S907: The first access network apparatus sends second information to the second access network apparatus.

For specific principles of the first information and the second information, refer to the related descriptions of S603. Details are not described herein again.

It may be understood that the second access network apparatus is used as an example in this embodiment of this application. If the first service cluster further includes another access node apparatus, for example, a third access node apparatus, the first access network apparatus may still send the second information to the access node apparatus. In addition, an execution sequence between S906 and S907 is not limited.
S908: The first terminal sends measurement information to the first access network apparatus.

For a specific principle of S908, refer to related descriptions of downlink measurement in S604. Details are not described herein again.
S909: The first terminal separately sends an uplink reference signal to the first access network apparatus and the second access network apparatus.
S910: The second access network apparatus sends uplink communication quality to the first access network apparatus.
S911: The first access network apparatus determines uplink communication quality between the first terminal and the first service cluster.

For a specific principle of S909 to S911, refer to related descriptions of uplink measurement in S604. Details are not described herein again.

It may be understood that an execution sequence between S908 and S909 to S911 is not limited, and S908 or S909 to S911 are optional steps, and may not be actually performed.

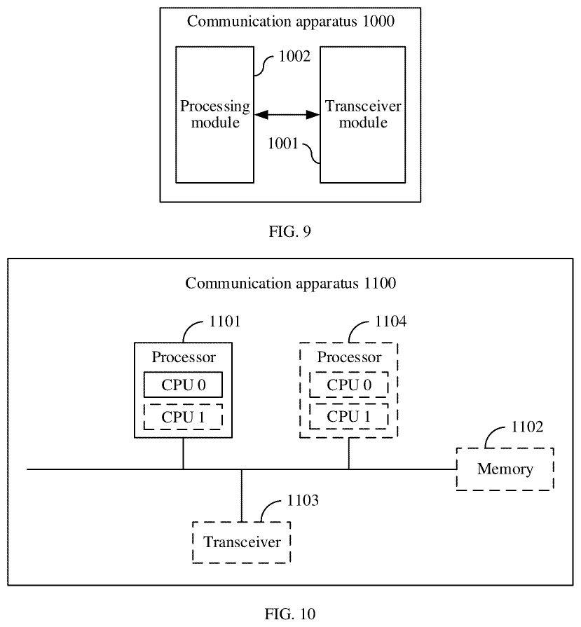

The foregoing describes in detail the communication methods provided in embodiments of this application with reference to FIG. 5 to FIG. 8. The following describes in detail communication apparatuses configured to perform the communication methods provided in embodiments of this application with reference to FIG. 9 and FIG. 10.

FIG. 9 is a diagram 1 of a structure of a communication apparatus according to an embodiment of this application. For example, as shown in FIG. 9, the communication apparatus 1000 includes a transceiver module 1001 and a processing module 1002. For ease of description, FIG. 9 shows only main components of the communication apparatus.

In some cases, the communication apparatus 1000 may be used in the communication system shown in FIG. 5, to perform a function of the first access network apparatus in the foregoing method. For example, the transceiver module 1001 is configured to perform receiving and sending functions of the communication apparatus 1000, and the processing module 1002 is configured to perform a function of the communication apparatus 1000 other than the receiving and sending functions.

Specifically, the transceiver module 1001 is configured to receive a candidate service cluster list. The processing module 1002 is configured to control, based on the candidate service cluster list, the transceiver module 1001 to send first information to a first terminal. The candidate service cluster list indicates one or more candidate service clusters, each of the one or more candidate service clusters includes one or more access network apparatuses, and each candidate service cluster includes the communication apparatus 1000. The first information indicates that a first service cluster serves the first terminal, and the first service cluster is a service cluster in the one or more candidate service clusters.

At least two access network apparatuses included in each of the one or more candidate service clusters are configured to jointly provide a service for a terminal, to ensure stability and reliability of the service.

In a possible design solution, the candidate service cluster list further indicates a service condition of the one or more candidate service clusters, and the first service cluster is a service cluster that meets a service condition.

Optionally, that the first service cluster meets the service condition includes at least one of the following items: A service area of the first service cluster covers a location of a terminal, current communication quality between the first service cluster and the terminal is higher than a communication quality threshold, a quantity of terminals currently served by the first service cluster is less than a preset quantity of terminals, or a quantity of currently available resources of the first service cluster is greater than a preset quantity of resources.

In a possible design solution, the first information includes at least one of the following items: an identifier of the first service cluster, an identifier of the first terminal, or an identifier of an access network apparatus included in the first service cluster.

In a possible design solution, the transceiver module 1001 is further configured to send second information to a second access network apparatus, where the second access network apparatus is an access network apparatus in the first service cluster, and the second information indicates information about the first service cluster.

Optionally, the information about the first service cluster includes at least one of the following items: the identifier of the first service cluster, an identifier of a terminal served by the first service cluster, or an identifier of the communication apparatus 1000.

In a possible design solution, the processing module 1002 is further configured to control, based on information from the first terminal, the transceiver module 1001 to send a candidate service cluster list request to a management network element. The transceiver module 1001 is further configured to receive the candidate service cluster list.

In a possible design solution, the transceiver module 1001 is further configured to periodically receive the candidate service cluster list from a management network element.

Optionally, the transceiver module 1001 is further configured to receive information from the first terminal. Correspondingly, the processing module 1002 is further configured to control, based on the candidate service cluster list in response to the information from the first terminal, the transceiver module 1001 to send the first information to the first terminal.

Optionally, the information from the first terminal includes at least one of the following items: representing that the first terminal successfully accesses the communication apparatus 1000, a measurement result of a downlink channel between the communication apparatus 1000 and the first terminal, or the information from the first terminal being an uplink reference signal sent by the first terminal.

In a possible design solution, the transceiver module 1001 is further configured to receive third information. The third information may indicate communication quality between the first terminal and the first service cluster.

Optionally, the transceiver module 1001 may include a sending module (not shown in FIG. 9) and a receiving module (not shown in FIG. 9). The sending module is configured to implement a sending function of the communication apparatus 1000, and the receiving module is configured to implement a receiving function of the communication apparatus 1000.

Optionally, the communication apparatus 1000 may further include a storage module (not shown in FIG. 9). The storage module stores a program or instructions. When the processing module 1002 executes the program or the instructions, the communication apparatus 1000 may perform a function of the foregoing method.

It may be understood that the communication apparatus 1000 may be a network device, may be a chip (system) or another part or component that may be disposed in the network device, or may be an apparatus including the network device. This is not limited in this application.

In addition, for technical effects of the communication apparatus 1000, refer to the technical effects of the communication methods shown in FIG. 5 to FIG. 8. Details are not described herein again.

In some other cases, the communication apparatus 1000 may be used in the communication system shown in FIG. 5, to perform a function of the management network element in the foregoing method. For example, the transceiver module 1001 is configured to perform receiving and sending functions of the communication apparatus 1000, and the processing module 1002 is configured to perform a function of the communication apparatus 1000 other than the receiving and sending functions.

Specifically, the processing module 1002 is configured to generate a candidate service cluster list, and the transceiver module 1001 is configured to send the candidate service cluster list to a first access network apparatus. The candidate service cluster list indicates one or more candidate service clusters, each of the one or more candidate service clusters includes one or more access network apparatuses, and each candidate service cluster includes the first access network apparatus.

In a possible design solution, a service cluster in the candidate service cluster list is a service cluster whose service performance is higher than preset service performance in a service cluster set.

Optionally, an access network apparatus included in each service cluster in the service cluster set is an access network apparatus managed by the communication apparatus 1000, each service cluster in the service cluster set includes one or more access network apparatuses, and each service cluster includes the first access network apparatus.

Further, service performance of any service cluster in the service cluster set is represented by using at least one of the following items: a communication capacity of the service cluster, a communication rate of the service cluster, or communication quality of the service cluster.

In a possible design solution, the candidate service cluster list further indicates a service condition of the one or more candidate service clusters.

Optionally, that a service cluster in the one or more candidate service clusters meets a service condition includes at least one of the following items: A service area of the service cluster covers a location of a terminal, current communication quality between the service cluster and the terminal is higher than a communication quality threshold, a quantity of terminals currently served by the service cluster is less than a preset quantity of terminals, or a quantity of currently available resources of the service cluster is greater than a preset quantity of resources.

In a possible design solution, the candidate service cluster list further indicates a priority of the one or more candidate service clusters, and the priority of the one or more candidate service clusters is determined based on respective service performance of the one or more candidate service clusters.

Optionally, the respective service performance of the one or more candidate service clusters is represented by using at least one of the following items: a respective communication capacity of the one or more candidate service clusters, a respective communication rate of the one or more candidate service clusters, or respective communication quality of the one or more candidate service clusters.

In a possible design solution, the transceiver module 1001 is further configured to receive a candidate service cluster list request from the first access network apparatus, and the processing module 1002 is further configured to generate the candidate service cluster list based on the candidate service cluster list request.

In a possible design solution, the processing module 1002 is further configured to periodically generate the candidate service cluster list.

Optionally, the transceiver module 1001 is further configured to periodically send the candidate service cluster list to the first access network apparatus.

In a possible design solution, at least two access network apparatuses included in each of the one or more candidate service clusters are configured to jointly provide a service for a terminal.

Optionally, the transceiver module 1001 may include a sending module (not shown in FIG. 9) and a receiving module (not shown in FIG. 9). The sending module is configured to implement a sending function of the communication apparatus 1000, and the receiving module is configured to implement a receiving function of the communication apparatus 1000.

Optionally, the communication apparatus 1000 may further include a storage module (not shown in FIG. 9). The storage module stores a program or instructions. When the processing module 1002 executes the program or the instructions, the communication apparatus 1000 may perform a function of the foregoing method.

It may be understood that the communication apparatus 1000 may be a network device, may be a chip (system) or another part or component that may be disposed in the network device, or may be an apparatus including the network device. This is not limited in this application.

In addition, for technical effects of the communication apparatus 1000, refer to the technical effects of the communication methods shown in FIG. 5 to FIG. 8. Details are not described herein again.

In still some other cases, the communication apparatus 1000 may be used in the communication system shown in FIG. 5, to perform a function of the first terminal in the foregoing method. For example, the transceiver module 1001 is configured to perform receiving and sending functions of the communication apparatus 1000, and the processing module 1002 is configured to perform a function of the communication apparatus 1000 other than the receiving and sending functions.

Specifically, the transceiver module 1001 is configured to receive first information from a first access network apparatus, and the processing module 1002 is configured to communicate with a first service cluster based on the first information. The first information indicates that the first service cluster serves the communication apparatus 1000, and one or more access network apparatuses included in the first service cluster include the first access network apparatus.

In a possible design solution, the processing module 1002 is further configured to control, based on the first information, the transceiver module 1001 to send measurement information to the first service cluster. The measurement information indicates communication quality between the communication apparatus 1000 and the first service cluster.

Optionally, the communication quality between the communication apparatus 1000 and the first service cluster is determined based on communication quality between the communication apparatus 1000 and each of the at least one access network apparatus in the first service cluster.

Optionally, the measurement information further includes an identifier of the first service cluster.

In another possible design solution, the processing module 1002 is further configured to control, based on the first information, the transceiver module 1001 to send a reference signal to the first service cluster, where the reference signal includes at least one of the following items: an identifier of the first service cluster or an identifier of the communication apparatus 1000.

Optionally, the transceiver module 1001 may include a sending module (not shown in FIG. 9) and a receiving module (not shown in FIG. 9). The sending module is configured to implement a sending function of the communication apparatus 1000, and the receiving module is configured to implement a receiving function of the communication apparatus 1000.

Optionally, the communication apparatus 1000 may further include a storage module (not shown in FIG. 9). The storage module stores a program or instructions. When the processing module 1002 executes the program or the instructions, the communication apparatus 1000 may perform a function of the foregoing method.

It may be understood that the communication apparatus 1000 may be a terminal, may be a chip (system) or another part or component that may be disposed in the terminal, or may be an apparatus including the terminal. This is not limited in this application.

In addition, for technical effects of the communication apparatus 1000, refer to the technical effects of the communication methods shown in FIG. 5 to FIG. 8. Details are not described herein again.

FIG. 10 is a diagram 2 of a structure of a communication apparatus according to an embodiment of this application. For example, the communication apparatus may be a network device, or may be a chip (system) or another part or component that may be disposed in the network device. As shown in FIG. 10, the communication apparatus 1100 may include a processor 1101. Optionally, the communication apparatus 1100 may further include a memory 1102 and/or a transceiver 1103. The processor 1101 is coupled to the memory 1102 and the transceiver 1103, for example, may be connected to the memory 1102 and the transceiver 1103 through a communication bus.

The following describes each part in the communication apparatus 1100 in detail with reference to FIG. 10.

The processor 1101 is a control center of the communication apparatus 1100, and may be one processor, or may be a general term of a plurality of processing elements. For example, the processor 1101 is one or more central processing units (CPUs), may be an application-specific integrated circuit (ASIC), or is configured as one or more integrated circuits implementing embodiments of this application, for example, one or more microprocessors (DSPs) or one or more field programmable gate arrays (FPGAs).

Optionally, the processor 1101 may perform various functions of the communication apparatus 1100 by running or executing a software program stored in the memory 1102 and invoking data stored in the memory 1102, for example, perform the communication methods shown in FIG. 5 to FIG. 8.

In specific implementation, in an embodiment, the processor 1101 may include one or more CPUs, for example, a CPU 0 and a CPU 1 shown in FIG. 10.

In specific implementation, in an embodiment, the communication apparatus 1100 may alternatively include a plurality of processors, for example, the processor 1101 and a processor 1104 shown in FIG. 10. Each of the processors may be a single-core processor (single-CPU), or may be a multi-core processor (multi-CPU). The processor herein may be one or more devices, circuits, and/or processing cores configured to process data (for example, computer program instructions).

The memory 1102 is configured to store a software program for performing the solutions in this application, and the processor 1101 controls execution of the software program. For a specific implementation, refer to the foregoing method embodiments. Details are not described herein again.

Optionally, the memory 1102 may be a read-only memory (ROM) or another type of static storage device that can store static information and instructions, or a random access memory (RAM) or another type of dynamic storage device that can store information and instructions, or may be an electrically erasable programmable read-only memory (EEPROM), a compact disc read-only memory (CD-ROM) or another optical disc storage, an optical disc storage (including a compact disc, a laser disc, an optical disc, a digital versatile disc, a Blu-ray disc, or the like), a magnetic disk storage medium or another magnetic storage device, or any other medium that can be configured to carry or store expected program code in a form of instructions or a data structure and that can be accessed by a computer. This is not limited thereto. The memory 1102 may be integrated with the processor 1101, or may exist independently, and is coupled to the processor 1101 through an interface circuit (not shown in FIG. 10) in the communication apparatus 1100. This is not specifically limited in this embodiment of this application.

The transceiver 1103 is configured to communicate with another communication apparatus. For example, the communication apparatus 1100 is a terminal, and the transceiver 1103 may be configured to communicate with a network device or communicate with another terminal device. For another example, the communication apparatus 1100 is a network device, and the transceiver 1103 may be configured to communicate with a terminal or another network device.

Optionally, the transceiver 1103 may include a receiver and a transmitter (not separately shown in FIG. 10). The receiver is configured to implement a receiving function, and the transmitter is configured to implement a sending function.

Optionally, the transceiver 1103 may be integrated with the processor 1101, or may exist independently, and is coupled to the processor 1101 through an interface circuit (not shown in FIG. 10) in the communication apparatus 1100. This is not specifically limited in this embodiment of this application.

It may be understood that, the structure of the communication apparatus 1100 shown in FIG. 10 does not constitute a limitation on the communication apparatus. An actual communication apparatus may include more or fewer parts than those shown in the figure, combine some parts, or have different part arrangement.

In addition, for technical effects of the communication apparatus 1100, refer to the technical effects of the method in the foregoing method embodiments. Details are not described herein again.

It should be understood that, the processor in embodiments of this application may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

It may be further understood that the memory in embodiments of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (erasable PROM, EPROM), an electrically erasable programmable read-only memory (electrically EPROM, EEPROM), or a flash memory. The volatile memory may be a random access memory (RAM), and is used as an external cache. By way of example, and not limitation, many forms of random access memories (RAMs) may be used, for example, a static random access memory (static RAM, SRAM), a dynamic random access memory (DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus dynamic random access memory (direct rambus RAM, DR RAM).

All or some of the foregoing embodiments may be implemented using software, hardware (for example, a circuit), firmware, or any combination thereof. When software is used to implement embodiments, the foregoing embodiments may be implemented fully or partially in a form of a computer program product. The computer program product includes one or more computer instructions or computer programs. When the computer instructions or the computer programs are loaded and executed on a computer, the procedure or functions according to embodiments of this application are fully or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for ease and brevity of description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on an actual need to achieve the objectives of the solutions of embodiments.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions in this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the method described in embodiments of this application. The storage medium includes any medium that can store program code, for example, a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, wherein the method comprises:
receiving, by a first access network apparatus, a candidate service cluster list, wherein the candidate service cluster list indicates one or more candidate service clusters, each of the one or more candidate service clusters comprises one or more access network apparatuses, and each candidate service cluster comprises the first access network apparatus; and
sending, by the first access network apparatus, first information to a first terminal based on the candidate service cluster list, wherein the first information indicates that a first service cluster serves the first terminal, and the first service cluster is a service cluster in the one or more candidate service clusters.

2. The method according to claim 1, wherein the candidate service cluster list further indicates a service condition of the one or more candidate service clusters, and the first service cluster is a service cluster that meets a service condition.

3. The method according to claim 2, wherein that the first service cluster meets the service condition comprises at least one of the following items: a service area of the first service cluster covers a location of a terminal, current communication quality between the first service cluster and the terminal is higher than a communication quality threshold, a quantity of terminals currently served by the first service cluster is less than a preset quantity of terminals, or a quantity of currently available resources of the first service cluster is greater than a preset quantity of resources.

4. The method according to claim 2, wherein the candidate service cluster list further indicates a priority of the one or more candidate service clusters, and the first service cluster is a service cluster with a highest priority in a candidate service cluster that meets the service condition.

5. The method according to claim 1, wherein the first information comprises at least one of the following items: an identifier of the first service cluster, an identifier of the first terminal, or an identifier of an access network apparatus comprised in the first service cluster.

6. The method according to claim 1, wherein the method further comprises:
sending, by the first access network apparatus, second information to a second access network apparatus, wherein the second access network apparatus is an access network apparatus in the first service cluster, and the second information indicates information about the first service cluster.

7. The method according to claim 6, wherein the information about the first service cluster comprises at least one of the following items: the identifier of the first service cluster, an identifier of a terminal served by the first service cluster, or an identifier of the first access network apparatus.

8. The method according to claim 1, wherein the receiving, by the first access network apparatus, the candidate service cluster list comprises:
sending, by the first access network apparatus, a candidate service cluster list request to a management network element based on information from the first terminal; and
receiving, by the first access network apparatus, the candidate service cluster list.

9. The method according to claim 1, wherein the receiving, by the first access network apparatus, the candidate service cluster list comprises:
periodically receiving, by the first access network apparatus, the candidate service cluster list from a management network element.

10. The method according to claim 9, wherein the method further comprises:
receiving, by the first access network apparatus, information from the first terminal; and
the sending, by the first access network apparatus, the first information to the first terminal based on the candidate service cluster list comprises:
sending, by the first access network apparatus in response to the information from the first terminal, the first information to the first terminal based on the candidate service cluster list.

11. The method according to claim 8, wherein the information from the first terminal comprises at least one of the following items: representing that the first terminal successfully accesses the first access network apparatus, a measurement result of a downlink channel between the first access network apparatus and the first terminal, or the information from the first terminal being an uplink reference signal sent by the first terminal.

12. The method according to claim 1, wherein the method further comprises:
receiving, by the first access network apparatus, third information, wherein the third information indicates communication quality between the first terminal and the first service cluster.

13. The method according to claim 1, wherein at least one access network apparatus comprised in each of the one or more candidate service clusters is configured to provide a service for a terminal.

14. A communication method, wherein the method comprises:
generating, by a management network element, a candidate service cluster list, wherein the candidate service cluster list indicates one or more candidate service clusters, each of the one or more candidate service clusters comprises one or more access network apparatuses, and each candidate service cluster comprises a first access network apparatus; and
sending, by the management network element, the candidate service cluster list to the first access network apparatus.

15. The method according to claim 14, wherein a service cluster in the candidate service cluster list is a service cluster whose service performance is higher than preset service performance in a service cluster set.

16. A communication method, wherein the method comprises:
receiving, by a first terminal, first information from a first access network apparatus,
wherein the first information indicates that a first service cluster serves the first terminal, and one or more access network apparatuses comprised in the first service cluster comprise the first access network apparatus; and
communicating, by the first terminal, with the first service cluster based on the first information.

17. The method according to claim 16, wherein the communicating, by the first terminal, with the first service cluster based on the first information comprises:
sending, by the first terminal, measurement information to the first service cluster based on the first information, wherein the measurement information indicates communication quality between the first terminal and the first service cluster.

18. The method according to claim 17, wherein the communication quality between the first terminal and the first service cluster is determined based on communication quality between the first terminal and each of at least one access network apparatus in the first service cluster.

19. The method according to claim 17, wherein the measurement information further comprises an identifier of the first service cluster.

20. The method according to claim 16, wherein the communicating, by the first terminal, with the first service cluster based on the first information comprises:
sending, by the first terminal, a reference signal to the first service cluster based on the first information.
